(19) United States
(12) Patent Application Publication
(10) Pub. No.: US 2025/0317898 A1
(43) Pub. Date: Oct. 9, 2025

(54) ADAPTIVE USER EQUIPMENT PAGING DETECTION

(71) Applicant: Dell Products L.P., Round Rock, TX (US)

(72) Inventor: Ali Esswie, Calgary (CA)

(21) Appl. No.: 18/627,319

(22) Filed: Apr. 4, 2024

(51) Int. Cl. H04W 68/02

(52) U.S. Cl. CPC H04W 68/02

(57) ABSTRACT

To conserve energy, a non-terrestrial network node may determine to delegate, or offload, during a paging occasion delegation period, paging, with respect to non-terrestrial user equipment that have selected the non-terrestrial node, to terrestrial paging occasions facilitated by a terrestrial network node. For user equipment beyond coverage of a terrestrial node, the non-terrestrial node may facilitate paging via non-terrestrial paging occasions that are different than the non-terrestrial occasions to be delegated. Responsive to a request from the non-terrestrial node indicative of the non-terrestrial occasions to be delegated, the terrestrial node may indicate, to the non-terrestrial node, terrestrial paging occasions corresponding to the non-terrestrial occasions to be delegated. The terrestrial node may indicate to a user equipment a paging occasion type. If an indicated type does not correspond to the user equipment the user equipment may avoid decoding a shared terrestrial occasion corresponding to the occasion type.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QOS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise analyzing, by a non-terrestrial radio network node comprising at least one processor, at least one energy parameter value, resulting from at least one energy parameter measurement, with respect to at least one energy saving criterion to result in an analyzed at least one energy parameter value. Based on the analyzed at least one energy parameter value being determined to satisfy the at least one energy saving criterion, the method may further comprise determining to delegate paging with respect to at least one first paging occasion to at least one second paging occasion, and facilitating, by the non-terrestrial radio network node, transmitting, to at least one user equipment configured to receive paging messages transmitted by the non-terrestrial radio network node via at least one first paging resource, a paging modification information message comprising modified paging resource information indicative of at least one second paging resource corresponding to the at least one second paging occasion.

In an embodiment, the method may further comprise facilitating, by the non-terrestrial radio network node, receiving, from the at least one user equipment, at least one terrestrial radio parameter measurement report, corresponding to the at least one user equipment, comprising at least one measured terrestrial signal strength value determined with respect to at least one terrestrial radio network node and analyzing, by the non-terrestrial radio network node, the at least one measured terrestrial signal strength value with respect to a node paging delegation criterion to result in at least one analyzed measured terrestrial signal strength value. Based on at least one of the at least one analyzed measured terrestrial signal strength value being determined to satisfy the node paging delegation criterion, facilitating, by the non-terrestrial radio network node, the method may further comprise directing, to the at least one terrestrial radio network node, a paging delegation request requesting that at least one of the at least one terrestrial radio network node facilitate delivery of at least one paging message, directed to the at least one user equipment, to the at least one user equipment.

In an embodiment, the paging delegation request may be directed to the at least one terrestrial radio network node via at least one of a non-terrestrial network gateway or a terrestrial-non-terrestrial shared entity.

In an embodiment, the method may further comprise, responsive to directing the paging delegation request to the at least one terrestrial radio network node, facilitating, by the non-terrestrial radio network node, receiving, from at least one of the at least one terrestrial radio network node, at least one paging occasion resource delegation message comprising at least one delegated paging occasion resource indication indicative of the at least one second paging resource corresponding to the at least one second paging occasion. The paging modification information message may comprise a delegated paging occasion indication indicative that paging is to be facilitated by the at least one of the at least one terrestrial radio network node via the at least one second paging occasion according to the at least one second paging resource.

In an embodiment, the paging delegation request may comprise at least one terrestrial node identifier, corresponding to at least one of the at least one terrestrial radio network node, indicated in the at least one of the at least one terrestrial radio parameter measurement report, usable by the at least one terrestrial radio network node to determine at least one terrestrial coverage area within which the at least one user equipment is located.

In an embodiment, the method may further comprise facilitating, by the non-terrestrial radio network node, receiving, from the at least one user equipment, at least one terrestrial radio parameter measurement report, corresponding to the at least one user equipment, comprising at least one measured terrestrial signal strength value determined with respect to at least one terrestrial radio network node, and analyzing, by the non-terrestrial radio network node, the at least one measured terrestrial signal strength value with respect to a node paging delegation criterion to result in at least one analyzed measured terrestrial signal strength value. Based on at least one of the at least one analyzed measured terrestrial signal strength value being determined to fail to satisfy the node paging delegation criterion, the transmitting of the paging modification information message may comprise transmitting the paging modification information message to at least one of the at least one user equipment corresponding to the at least one of the at least one analyzed measured terrestrial signal strength value being determined to fail to satisfy the node paging delegation criterion, and wherein the at least one second paging resource comprises a non-terrestrial network resource corresponding to the non-terrestrial radio network node.

In an embodiment the method may further comprise facilitating, by the non-terrestrial radio network node, receiving, from a non-terrestrial network element, a paging indication indicative of a paging message directed to at least one of the at least one user equipment, and facilitating, by the non-terrestrial radio network node, transmitting, to the at least one of the at least one user equipment, the paging indication to be transmitted to the at least one of the at least one user equipment according to the at least one second paging resource.

The method may further comprise facilitating, by the non-terrestrial radio network node, establishing a connection with the at least one user equipment responsive to a paging message indicated by the paging indication.

In an embodiment, the paging modification information message may comprise paging delegation time information comprising at least one paging delegation time indication indicative of a delegation period during which paging to be facilitated by the non-terrestrial radio network node is delegated to being facilitated by a terrestrial radio network node via the at least one second paging occasion according to the at least one second paging resource.

In an embodiment, the method may further comprise facilitating, by the non-terrestrial radio network node, receiving the at least one energy saving criterion from at least one of: a terrestrial-non-terrestrial shared entity; a non-terrestrial network gateway, or a terrestrial radio network node.

In an embodiment, the method may further comprise facilitating, by the non-terrestrial radio network node, receiving at least part of the modified paging resource information from at least one of: a terrestrial-non-terrestrial shared entity; a non-terrestrial network gateway, or a terrestrial radio network node.

In another example embodiment, a non-terrestrial radio network node may comprise at least one processor configured to process executable instructions that, when executed by the at least one processor, may facilitate performance of operations that may comprise receiving, from at least one user equipment, at least one terrestrial radio parameter measurement report, corresponding to the at least one user equipment, comprising at least one measured terrestrial signal strength value determined with respect to at least one terrestrial radio network node, analyzing the at least one measured terrestrial signal strength value with respect to a node paging delegation criterion to result in at least one analyzed measured terrestrial signal strength value. Based on at least one of the at least one analyzed measured terrestrial signal strength value being determined to satisfy the node paging delegation criterion, the method may further comprise directing, to the at least one terrestrial radio network node, a paging delegation request requesting that at least one of the at least one terrestrial radio network node facilitate delivery of at least one paging message, directed to the at least one user equipment, to the at least one user equipment. Responsive to directing the paging delegation request to the at least one terrestrial radio network node, the method may further comprise receiving, from at least one of the at least one terrestrial radio network node, at least one paging occasion resource delegation message comprising at least one delegated paging occasion resource indication indicative of at least one delegated paging resource corresponding to at least one delegated paging occasion, usable by the at least one user equipment to during a paging delegate period activated by the non-terrestrial radio network node. The method may further comprise transmitting, to at one of the at least one user equipment, configured to receive paging indications transmitted by the non-terrestrial radio network node via at least one nondelegated paging resource, a paging modification information message comprising modified paging resource information indicative of the at least one delegated paging resource.

In an embodiment, the operations may further comprise analyzing at least one energy parameter value, resulting from at least one energy parameter measurement, with respect to at least one energy saving criterion to result in an analyzed at least one energy parameter value, wherein the transmitting of the paging modification information message is based on the analyzed at least one energy parameter value being determined to satisfy the at least one energy saving criterion. The at least one energy parameter value comprises at least one of a battery charge value or an energy consumption rate. The operations may further comprise receiving the at least one energy saving criterion from at least one of: a terrestrial-non-terrestrial shared entity; a non-terrestrial network gateway, or a terrestrial radio network node.

In an embodiment, the paging modification information message may comprise paging delegation time information comprising at least one paging delegation time indication indicative of a delegation period during which paging to be facilitated by the non-terrestrial radio network node is delegated to being facilitated by a terrestrial radio network node via the at least one delegate paging occasion according to the at least one delegate paging resource.

In yet another example embodiment, a non-transitory machine-readable medium may comprise executable instructions that, when executed by at least one processor of a non-terrestrial radio network node, may facilitate performance of operations that may comprise receiving, from at least one user equipment, at least one terrestrial radio parameter measurement report, corresponding to the at least one user equipment, comprising at least one measured terrestrial signal strength value determined with respect to at least one terrestrial radio network node, and analyzing the at least one measured terrestrial signal strength value with respect to a node paging delegation criterion to result in at least one analyzed measured terrestrial signal strength value. Based on at least one of the at least one analyzed measured terrestrial signal strength value being determined to fail to satisfy the node paging delegation criterion, the operations may further comprise transmitting a paging modification information message to at least one of the at least one user equipment corresponding to the at least one of the at least one analyzed measured terrestrial signal strength value being determined to fail to satisfy the node paging delegation criterion. The paging modification information message may comprise a non-terrestrial network resource indication indicative of at least one delegated non-terrestrial network paging resource, corresponding to the non-terrestrial radio network node, usable by the at least one of the at least one user equipment to receive paging indications during a delegated paging period. The at least one of the at least one user equipment may be configured to use at least one nondelegated non-terrestrial network paging resource during a nondelegated paging period.

In an embodiment, the operations may further comprise analyzing at least one energy parameter value, resulting from at least one energy parameter measurement, with respect to at least one energy saving criterion to result in an analyzed at least one energy parameter value, wherein the transmitting of the paging modification information message is further based on the analyzed at least one energy parameter value being determined to satisfy the at least one energy saving criterion.

The at least one delegated non-terrestrial network paging resource may comprise a smaller resource than the at least one nondelegated non-terrestrial network paging resource.

The at least one nondelegated non-terrestrial network paging resource may comprise at least one first at least one nondelegated non-terrestrial network paging resource and at least one second at least one nondelegated non-terrestrial network paging resource. The paging modification information message comprises at least one deactivated paging occasion indication indicative of fewer than all of the at least one first at least one nondelegated non-terrestrial network paging resource and at least one second at least one nondelegated non-terrestrial network paging resource being unusable by the at least one user equipment during the delegated paging period.

In another example embodiment a method may comprise facilitating, by a terrestrial radio network node comprising at least one processor, receiving, from a first non-terrestrial network element, a paging delegation request that requests facilitation, by the terrestrial radio network node, of paging on behalf of a non-terrestrial radio network node during a delegated paging period operated by the non-terrestrial radio network node. The method may further comprise facilitating, by the terrestrial radio network node, transmitting, to a second non-terrestrial network element, a paging occasion resource delegation message comprising at least one delegated paging occasion resource indication indicative of at least one terrestrial paging resource usable by at least one user equipment, associated with the non-terrestrial radio network node, to receive at least one paging message during the delegated paging period. The method may comprise facilitating, by the terrestrial radio network node, receiving, from a third non-terrestrial network element, a paging indication to be transmitted to at least one of the at least one user equipment during the delegated paging period. The method may further comprise facilitating, by the terrestrial radio network node during the delegated paging period, transmitting, to the at least one of the at least one user equipment, the paging indication according to the at least one terrestrial paging resource.

The paging delegation request may comprise at least one terrestrial network node identifier, corresponding to at least one terrestrial radio network node with respect to which the at least one user equipment has reported at least one measured signal strength value associated with the at least one terrestrial radio network node, usable to facilitate determining, by the terrestrial radio network node or by a core network element associated with the terrestrial radio network node, at least one tracking area corresponding to the at least one user equipment.

The paging delegation request may comprise at least one non-terrestrial network paging occasion indication indicative of at least one non-terrestrial network paging occasion, with respect to which the non-terrestrial radio network node is configured to use to deliver paging indications to at least one of the at least one user equipment associated with the non-terrestrial radio network node, that is to be unusable by the non-terrestrial radio network node to deliver paging indications to the at least one of the at least one user equipment during the delegated paging period.

In an embodiment, the at least one terrestrial paging resource usable by at least one user equipment, indicated by the paging occasion resource delegation message, may correspond to the at least one non-terrestrial network paging occasion that is to be unusable by the non-terrestrial radio network node to deliver paging indications to the at least one of the at least one user equipment during the delegated paging period.

In an embodiment, the paging delegation request comprises at least one terrestrial network node identifier, corresponding to at least one terrestrial radio network node with respect to which the at least one of the at least one user equipment, configured to monitor the at least one non-terrestrial network paging occasion that is to be unusable by the non-terrestrial radio network node to deliver paging indications, has reported at least one measured signal strength value associated with the at least one terrestrial radio network node, usable to facilitate determining, by the terrestrial radio network node or by a core network element associated with the terrestrial radio network node, at least one tracking area corresponding to the at least one user equipment. The at least one of the at least one user equipment, to which the paging indication may be transmitted according to the at least one terrestrial paging resource, may correspond to a tracking area that does not correspond to the terrestrial radio network node.

In an embodiment, the at least one user equipment may comprise at least one non-terrestrial user equipment associated with the non-terrestrial radio network node. The at least one terrestrial paging resource may comprise a shared paging occasion resource usable, by at least one terrestrial user equipment associated with the terrestrial radio network node and usable by the at least one non-terrestrial user equipment, to receive at least one paging message during the delegated paging period.

In an embodiment, the at least one terrestrial paging resource may comprise a paging occasion type occasion resource, wherein the at least one delegated paging occasion resource indication is indicative of the paging occasion type occasion resource, and wherein the paging occasion type occasion resource is usable, by the terrestrial radio network node, to deliver a paging occasion type indication, indicative to the at least one terrestrial user equipment and the at least one non-terrestrial user equipment, that the shared paging occasion resource corresponds to a shared paging occasion that comprises at least one paging message directed to at least one of the at least one terrestrial user equipment or directed to at least one of the at least one non-terrestrial user equipment. A paging occasion size associated with the shared paging occasion may correspond to the paging occasion type indication. A shared paging occasion may comprise a longer duration or a larger frequency range than a paging occasion usable only to deliver paging indications to terrestrial user equipment or usable only to deliver paging indications to non-terrestrial user equipment.

In an embodiment, the first non-terrestrial network element and the second non-terrestrial network element may be the same.

In an embodiment, the first non-terrestrial network element, the second non-terrestrial network element, or the third non-terrestrial network element may comprise at least one of: a non-terrestrial network gateway, a terrestrial-non-terrestrial shared entity, or the non-terrestrial radio network node.

In an embodiment, the non-terrestrial radio network node may comprise a satellite.

The at least one user equipment being associated with the non-terrestrial radio network node may comprise the at least one user equipment operating in an idle mode and being camped on the non-terrestrial radio network node.

In another example embodiment, a terrestrial radio network node may comprise at least one processor configured to process executable instructions that, when executed by the at least one processor, may facilitate performance of operations that may comprise receiving, from a non-terrestrial network element, a paging delegation request that requests facilitation, by the terrestrial radio network node, of paging on behalf of a non-terrestrial radio network node during a delegated paging period operated by the non-terrestrial radio network node. Responsive to the paging delegation request, the operations may further comprise transmitting, to the non-terrestrial network element, a paging occasion resource delegation message comprising at least one delegated paging occasion resource indication indicative of at least one terrestrial paging resource usable by a non-terrestrial user equipment to receive at least one paging message during the delegated paging period. The operations may comprise receiving, from the non-terrestrial network element, a paging indication to be transmitted to the non-terrestrial user equipment during the delegated paging period and transmitting, to the non-terrestrial user equipment, the paging indication according to the at least one terrestrial paging resource.

In an embodiment, the at least one terrestrial paging resource may comprise a shared paging occasion resource usable by the non-terrestrial user equipment, and usable by at least one terrestrial user equipment associated with the terrestrial radio network node, to receive at least one paging message during the delegated paging period.

In an embodiment, the at least one terrestrial paging resource may comprise a paging occasion type occasion resource. The at least one delegated paging occasion resource indication may be indicative of the paging occasion type occasion resource. The paging occasion type occasion resource may be usable, by the terrestrial radio network node, to deliver a paging occasion type indication, indicative to the at least one terrestrial user equipment and the non-terrestrial user equipment, that the shared paging occasion resource corresponds to a shared paging occasion that comprises at least one paging message directed to at least one of the at least one terrestrial user equipment or the non-terrestrial user equipment. In an embodiment, a paging occasion size associated with the shared paging occasion may correspond to the paging occasion type indication.

In yet another example embodiment, a non-transitory machine-readable medium may comprise executable instructions that, when executed by at least one processor of a terrestrial radio network node, may facilitate performance of operations that may comprise receiving, from a non-terrestrial network element, a paging delegation request that requests facilitation, by the terrestrial radio network node, of paging, with respect to at least one non-terrestrial paging occasion, on behalf of a non-terrestrial radio network node during a delegated paging period operated by the non-terrestrial radio network node. Responsive to the paging delegation request, the operations may further comprise transmitting, to the non-terrestrial network element, a paging occasion resource delegation message comprising at least one delegated paging occasion resource indication indicative of at least one terrestrial paging resource usable by a user equipment, configured to receive paging messages via the at least one non-terrestrial paging occasion, to receive, from the terrestrial radio network node, at least one paging message during the delegated paging period. Based on paging occasion assignment information indicated by the paging delegation request, the operations may further comprise determining a tracking area corresponding to the user equipment to result in a determined tracking area.

In an embodiment, the terrestrial radio network node is a first terrestrial radio network node. The determined tracking area may correspond to a second terrestrial radio network node. The operations may further comprise directing the paging delegation request to the second terrestrial radio network node.

In an embodiment, the determined tracking area may correspond to the terrestrial radio network node. The user equipment may be a non-terrestrial user equipment. The at least one terrestrial paging resource may comprise a shared paging occasion resource usable by the non-terrestrial user equipment and usable by at least one terrestrial user equipment associated with the terrestrial radio network node to receive at least one paging message during the delegated paging period. The at least one terrestrial paging resource may comprise a paging occasion type occasion resource. The paging occasion type occasion resource may be usable, by the terrestrial radio network node, to deliver a paging occasion type indication, indicative to the non-terrestrial user equipment and the at least one terrestrial user equipment, that the shared paging occasion resource corresponds to a shared paging occasion that comprises at least one paging message directed to at least one of the at least one terrestrial user equipment or the non-terrestrial user equipment. The operations may further comprise receiving, from the non-terrestrial network element, a paging indication to be transmitted to the non-terrestrial user equipment during the delegated paging period. The operations may further comprise transmitting, via the paging occasion type occasion resource, a paging occasion type indication indicative that a shared paging occasion associated with the paging occasion type indication is to comprise a non-terrestrial paging indication directed to a non-terrestrial user equipment, and transmitting, to the non-terrestrial user equipment, the non-terrestrial paging indication according to the shared paging occasion resource.

In another example embodiment, a method may comprise receiving, by a user equipment comprising at least one processor from a non-terrestrial radio network node, a paging modification information message comprising modified paging resource information indicative of at least one first paging resource, corresponding to at least one first paging occasion, usable by the user equipment during a paging delegation period implemented by the non-terrestrial radio network node, wherein the user equipment is configured to receive, during a paging non-delegation period corresponding to the non-terrestrial radio network node, paging messages transmitted by the non-terrestrial radio network node via at least one second paging resource corresponding to at least one second paging occasion. Based on the modified paging resource information, the method may further comprise receiving, by the user equipment during the paging delegation period, a paging indication via at least one of the at least one first paging occasion according to the at least one first paging resource. Based on the paging indication, the method may comprise performing, by the user equipment, a network operation.

In an embodiment, the method may further comprise determining, by the user equipment, that the paging indication is directed to the user equipment to result in a determined paging indication. Responsive to the determined paging indication being determined to be directed to the user equipment, the performing of the network operation may comprise transitioning to an active mode.

In an embodiment, the at least one first paging resource may be a terrestrial paging resource corresponding to a terrestrial radio network node. The performing of the network operation may comprise establishing a connection with the terrestrial radio network node.

In an embodiment, the method may further comprise transmitting, by the user equipment to the non-terrestrial radio network node, a radio parameter measurement report comprising at least one measured terrestrial signal strength value determined with respect to at least the terrestrial radio network node. Based on at least one of the at least one measured terrestrial signal strength value being determined by the non-terrestrial radio network node to fail to satisfy a node paging delegation criterion, the at least one first paging resource may comprise a non-terrestrial paging resource corresponding to the non-terrestrial radio network node. The performing of the network operation may comprise establishing a connection with the non-terrestrial radio network node.

In an embodiment, the user equipment may be a non-terrestrial-network user equipment that is associated with the non-terrestrial radio network node. The at least one first paging resource may comprise at least one shared paging occasion resource usable by at least one terrestrial user equipment associated with a terrestrial radio network node and usable by the non-terrestrial-network user equipment to receive, during the paging delegation period, at least one paging message transmitted by the terrestrial radio network node. The at least one first paging resource may further comprise at least one paging occasion type occasion resource usable, by the non-terrestrial-network user equipment or the at least one terrestrial user equipment, to receive a paging occasion type indication indicative of at least one shared paging occasion comprising at least one paging message directed to at least one of the at least one terrestrial user equipment or a group of non-terrestrial-network user equipment comprising the non-terrestrial-network user equipment.

In an embodiment, the method may further comprise receiving, by the non-terrestrial-network user equipment via the at least one paging occasion type occasion resource, a paging occasion type indication indicative that the at least one shared paging occasion comprises a paging message directed to the non-terrestrial-network user equipment. The method may comprise receiving, by the non-terrestrial-network user equipment via the at least one shared paging occasion resource, the paging message. The network operation may further comprise, responsive to the paging message, establishing a connection with the non-terrestrial radio network node.

In an embodiment, the method may further comprise receiving, by the non-terrestrial-network user equipment via the at least one paging occasion type occasion resource, a paging occasion type indication indicative that the at least one shared paging occasion excludes a paging message directed to the non-terrestrial-network user equipment. The network operation may further comprise avoiding transitioning from an idle state to a connected state.

In an embodiment, the modified paging resource information may comprise at least one paging delegation time indication indicative of the paging delegation period.

In another example embodiment, a user equipment may comprise at least one processor configured to process executable instructions that, when executed by the at least one processor, may facilitate performance of operations that may comprise receiving, from a non-terrestrial radio network node, a paging modification information message comprising modified paging resource information indicative of at least one terrestrial paging resource corresponding to at least one terrestrial paging occasion and at least one first non-terrestrial paging resource corresponding to at least one first non-terrestrial paging occasion. The at least one terrestrial paging resource or the at least one first non-terrestrial paging resource may be usable by the user equipment during a paging delegation period implemented by the non-terrestrial radio network node. The user equipment may be configured to receive, during a paging non-delegation period corresponding to the non-terrestrial radio network node, paging messages transmitted by the non-terrestrial radio network node via at least one second non-terrestrial paging resource corresponding to at least one second non-terrestrial paging occasion. The operations may further comprise transmitting, by the user equipment to the non-terrestrial radio network node, a radio parameter measurement report comprising at least one measured terrestrial signal strength value determined with respect to at least one terrestrial radio network node. Based on the at least one measured terrestrial signal strength value being determined by the non-terrestrial radio network node to fail to satisfy a node paging delegation criterion, the operations may further comprise receiving, during the paging delegation period, a paging indication via at least one of the at least one first non-terrestrial paging occasion according to the at least one first non-terrestrial paging resource. Based on the paging indication, the operations may further comprise establishing a connection with the non-terrestrial radio network node.

The at least one terrestrial paging occasion or the at least one first non-terrestrial paging occasion may be respectively associated in the paging modification information message with the at least one second non-terrestrial paging occasion.

In another example embodiment, a non-transitory machine-readable medium may comprise executable instructions that, when executed by at least processor of a user equipment, may facilitate performance of operations that may comprise selecting a non-terrestrial radio network node to be a serving node with respect to the user equipment. The user equipment may be configured to receive, during a paging non-delegation period corresponding to the non-terrestrial radio network node, paging messages transmitted by the non-terrestrial radio network node via at least one non-terrestrial paging resource corresponding to at least one non-terrestrial paging occasion. The operations may further comprise receiving, from the non-terrestrial radio network node, a paging modification information message comprising modified paging resource information indicative of at least one terrestrial resource, corresponding to at least one terrestrial paging occasion, usable, by the user equipment, to receive paging message during a paging delegation period implemented by the non-terrestrial radio network node. Based on the modified paging resource information, the operations may further comprise receiving, by the user equipment from a terrestrial radio network node during the paging delegation period, a paging indication via at least one of the at least one terrestrial paging occasion according to the at least one terrestrial paging resource. Based on the paging indication, the operations may further comprise performing, by the user equipment, a network operation.

The user equipment may be, or may be referred to as, a non-terrestrial-network user equipment based on selecting by the user equipment of the non-terrestrial radio network node. The at least one terrestrial paging resource may comprise at least one shared paging occasion resource usable by at least one terrestrial user equipment, which may be referred to as a terrestrial user equipment due to having selected the terrestrial radio network node to be a serving node with respect to the at least one terrestrial user equipment, and usable by the at least one non-terrestrial-network user equipment to receive, during the paging delegation period, at least one paging message transmitted by the terrestrial radio network node.

In an embodiment, the at least one terrestrial paging resource further may comprise at least one paging occasion type occasion resource usable, by the non-terrestrial-network user equipment or the at least one terrestrial user equipment, to receive a paging occasion type indication indicative of at least one shared paging occasion comprising at least one paging message directed to at least one of the at least one terrestrial user equipment or a group of non-terrestrial user equipment comprising the non-terrestrial-network user equipment.

The operations may further comprise receiving, via the at least one paging occasion type occasion resource, a paging occasion type indication indicative that the at least one shared paging occasion comprises a paging message directed to the non-terrestrial-network user equipment, and receiving, via the at least one shared paging occasion resource, the paging message. The network operation further comprises, responsive to the paging message, establishing a connection with the non-terrestrial radio network node. The operations may further comprise receiving, by the non-terrestrial-network user equipment via the at least one paging occasion type occasion resource, a paging occasion type indication indicative that the at least one shared paging occasion excludes a paging message directed to the non-terrestrial-network user equipment. The network operation may further comprise avoiding transitioning from an idle state to a connected state.

In an embodiment, the at least one paging occasion type occasion resource may be smaller than the at least one shared paging occasion resource.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with a non-terrestrial radio network node facilitating delegating paging to a terrestrial network node.

FIG. 4 illustrates an example shared terrestrial shared paging occasion resource indicated by a shared paging occasion type occasion resource.

FIG. 5 illustrates example energy saving criteria configuration information.

FIG. 6 illustrates an example non-terrestrial network node paging occasion override indication.

FIG. 7 illustrates an example paging delegation request.

FIG. 8 illustrates an example paging occasion resource delegation message.

FIG. 9 illustrates an example paging modification information message.

FIG. 10 illustrates an example paging halting/delegation information message.

FIG. 11 illustrates a timing diagram of a non-terrestrial radio network node delegating paging via a configured paging occasion to being delivered via a delegated paging occasion.

FIG. 12 illustrates a timing diagram of a user terrestrial radio network node being configured to relay a paging indication via a delegated paging occasion.

FIG. 13 illustrates a timing diagram of a user equipment being configured to receive a paging indication via a delegated paging occasion.

FIG. 14 illustrates a flow diagram of an example method to facilitate an idle user equipment receiving a paging indication via a delegated paging occasion.

FIG. 15 illustrates a block diagram of an example method.

FIG. 16 illustrates a block diagram of an example terrestrial radio network node.

FIG. 17 illustrates a block diagram of an example non-transitory machine-readable medium.

FIG. 18 illustrates a block diagram of an example method.

FIG. 19 illustrates a block diagram of an example non-terrestrial radio network node.

FIG. 20 illustrates a block diagram of an example non-transitory machine-readable medium.

FIG. 21 illustrates a block diagram of an example method.

FIG. 22 illustrates a block diagram of an example user equipment.

FIG. 23 illustrates a block diagram of an example non-transitory machine-readable medium.

FIG. 24 illustrates an example computer environment.

FIG. 25 illustrates a block diagram of an example wireless UE.

FIG. 26A illustrates non-terrestrial delegated paging occasions.

FIG. 26B illustrates terrestrial delegated paging occasions.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions.

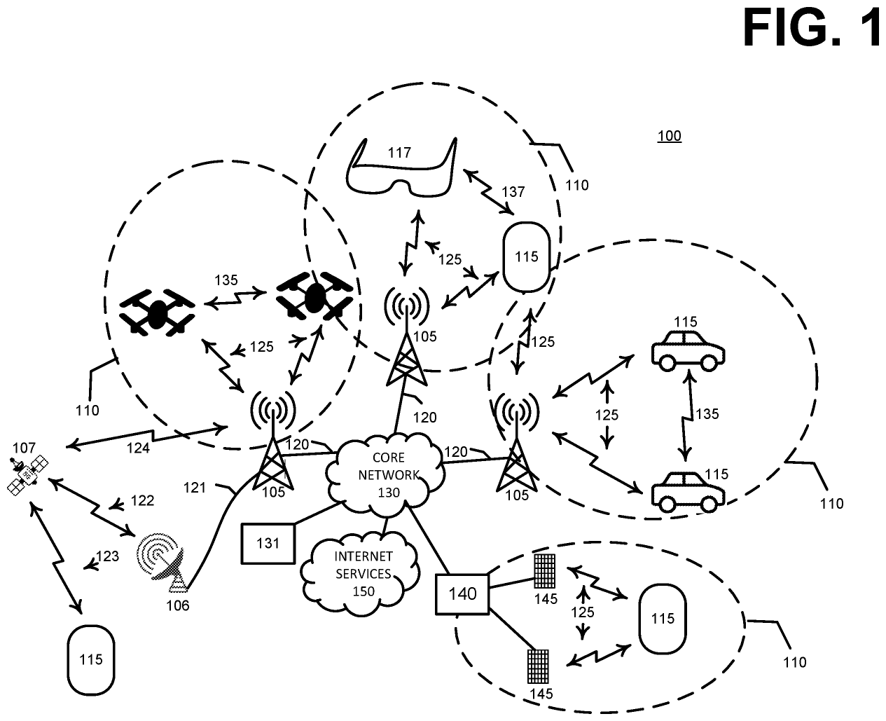

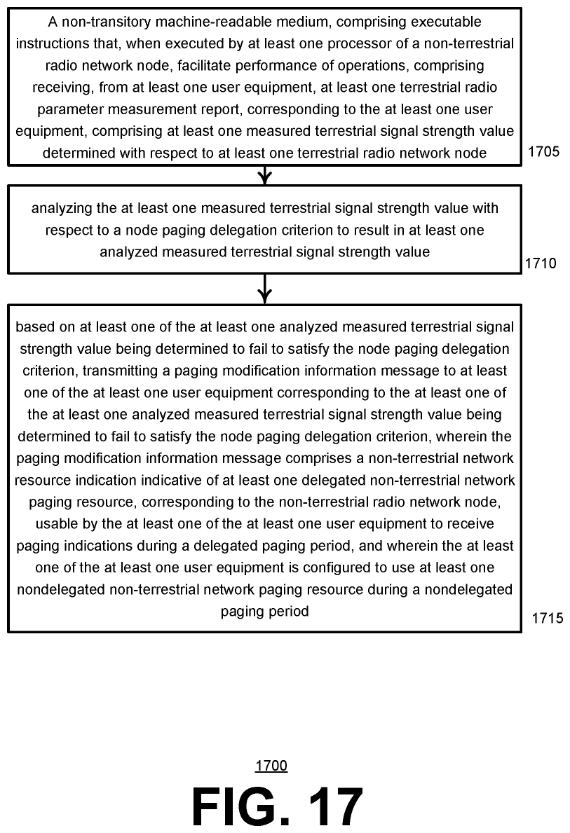

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 17.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description of herein, or reference to herein, a radio node or a radio network node may be a description or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

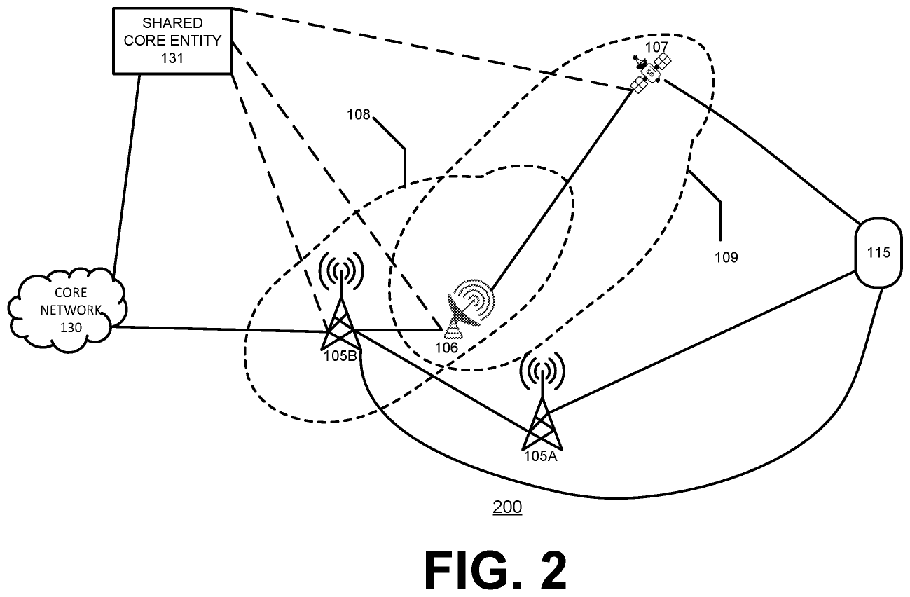

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

It may be desirable to implement gNodeB/RAN node functionality on board an NTN node/satellite node to serve user equipment. However, implementing RAN node functionality in an NTN node may give rise to performance limitations that may impact overall operation. For example, an NTN node implementing gNodeB functionality may consume energy at a rate similar to, or greater than, an energy consumption rate corresponding to a terrestrial RAN node due to providing similar functionality as the terrestrial node but providing the functionality to a potentially much larger number of user equipment because of a much wider coverage area corresponding to a non-terrestrial node with respect to a coverage are corresponding to a terrestrial node. Moreover, a non-terrestrial network node typically operates with a more limited energy source (e.g., a battery) as compared to an energy source corresponding to a terrestrial node (e.g., connection to a local electric power grid).

Therefore, it is desirable to offload energy-consumption-heavy radio operations from an NTN node to a terrestrial node if power consumed by an NTN/satellite node is deemed excessive or poses a risk to the NTN node/satellite (e.g., tending to cause a dead battery at the NTN node). Paging is a radio operation facilitated by a node that tends to be an energy-heavy operation due to broadcasting of paging indication/request messages to idle user equipment. Due to the significantly large NTN coverage footprint relative to a coverage footprint corresponding to a terrestrial radio network node, paging by an NTN node may comprise many multiple transmission repetitions of a paging request via many NTN downlink beams resulting in a high power-consumption rate to facilitate delivery of a paging message.

Accordingly, as disclosed herein, delegation of paging from an NTN node to a TN node of part of, or all of, energy-consumption-heavy paging broadcasts may be dynamically implemented during a paging delegation period, which may be referred to as a delegated paging period or a delegation period, to reduce energy consumption at the NTN node. As disclosed herein, due to various conditions existing at an NTN-capable user equipment device (e.g., some NTN user equipment devices may or may not ‘see’ reasonable ground coverage or signal strength, with respect to a terrestrial network node, that can facilitate paging on behalf of an NTN node), the NTN node may retain paging with respect to the NTN-capable user equipment device but use a different paging occasion resource than a paging occasion resource that may be used during a nondelegation period. (A nondelegation period may be the same duration as, or a different duration than, a delegation period.) As disclosed herein, a TN node may relay NTN paging indications (e.g., paging directed, via an NTN node, to an NTN-capable user equipment that has selected the NTN node) via TN paging occasion resources without disrupting TN node paging operation with respect to terrestrial user equipment (e.g., with respect to user equipment that have selected the TN node). An NTN device (e.g., an NTN-capable user equipment that has selected a non-terrestrial network node) may dynamically determine paging detection, as disclosed herein, either via an NTN paging occasion that is configured as a result of the user equipment having selected the NTN node or via a TN paging occasion.

According to conventional techniques, an NTN RAN node or a TN RAN node facilitates paging all idle user equipment devices that have selected the node. According to embodiments disclosed herein, an energy-critical NTN RAN node (e.g., an NTN node with respect to which a measured energy value associated with an energy parameter exceeds a corresponding energy parameter criterion) may temporarily offload to one or more TN RAN nodes some, or all, paging via one or more NTN paging occasions, with respect to which NTN-capable user equipment may be configured to monitor and decode, to other paging occasions that may be facilitated by the TN RAN node(s).

According to conventional techniques, for mobile terminated applications or services, a RAN node only accepts connection establishment requests from user equipment devices the node has paged. According to embodiments disclosed herein, wherein an NTN node has delegated paging via a non-terrestrial paging occasion to a terrestrial RAN node via a terrestrial paging occasion, the NTN RAN node may accept a connection request from an NTN user equipment device that the TN RAN node paged and that the NTN RAN node did not page.

According to conventional techniques, a TN RAN node only broadcasts, or multicasts, a paging request toward idle mode user equipment that have camped-on/selected the TN RAN node and that are located in a particular tracking area corresponding to the TN RAN node. According to embodiments disclosed herein, a TN RAN node may relay a paging indication, on behalf of an NTN node, to NTN user equipment devices that do not belong to, are not associated with, do not correspond to, or that have not selected and camped on, the TN RAN node. In embodiments disclosed herein, a TN RAN node may use a paging occasion type indication to indicate to user equipment that a particular terrestrial paging occasion that is usable by the TN RAN, and comprises a sharable paging occasion, comprises a paging indication directed to a user equipment that may have selected the TN RAN node or that has selected a NTN RAN node.

According to conventional techniques, a user equipment device only detects paging indications transmitted via a single radio interface that corresponds to a RAN node that the user equipment has selected based on a received coverage level corresponding to the RAN node. According to embodiments disclosed herein, a user equipment may dynamically implement paging occasion monitoring of paging occasions corresponding to either a TR RAN node or an NTN RAN node, which may have delegated paging to the TN RAN node based on an energy-consumption at the NTN node triggering the delegating. A user equipment may monitor and detect a paging occasion paging occasion type indication, which may trigger, or may trigger avoiding, monitoring and detecting a shared paging occasion.

### Paging Delegation of Non-Terrestrial Networks.

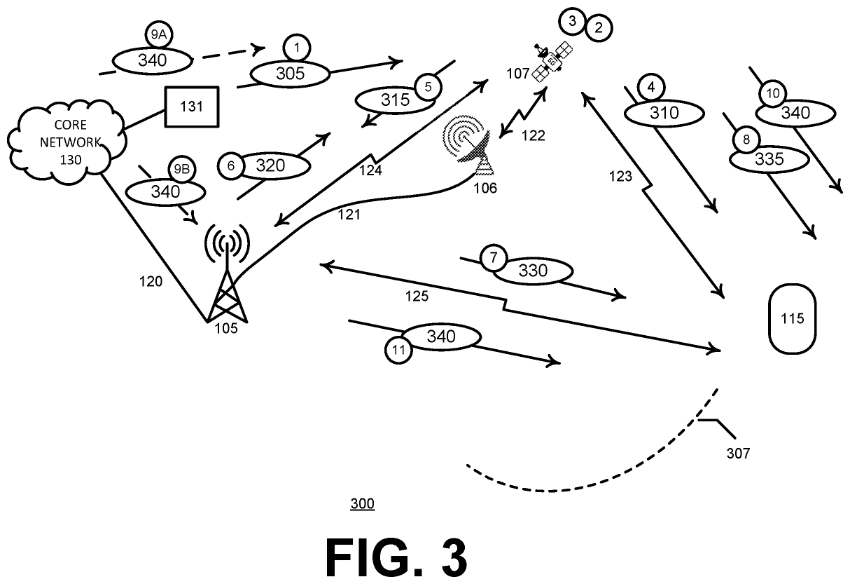

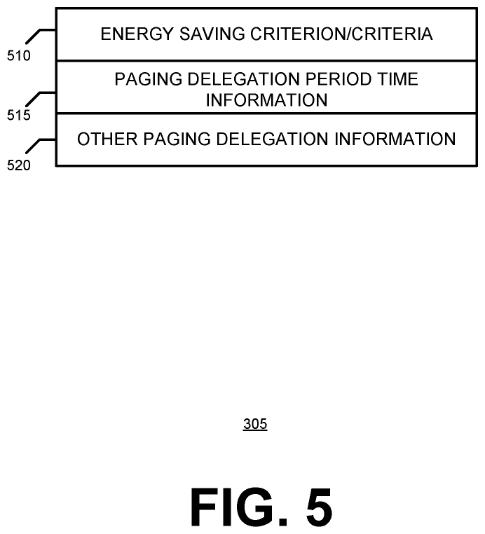

Turning now to FIG. 3, the figure illustrates an environment 300 with a user equipment 115 having selected NTN node 107 as a serving node (e.g., the UE is operating in an idle mode with respect to, and is camped on, node 107). UE 115 may be, or may not be, in a coverage range of terrestrial radio network node 105. At act 1, non-terrestrial network node 107 may receive an energy saving criterion message 305 from at least one of terrestrial/non-terrestrial core network shared entity 131, non-terrestrial network gateway 106, or terrestrial radio network node 105. Criterion message 305 may comprise a criterion 510 (shown in FIG. 5), for example an energy consumption threshold, and/or an indication of one or more scheduled time periods 515 during which NTN node 107 may enable halting, or delegation, of paging via NTN paging occasions according to which UE 115 may have been configured to receive paging indications from NTN node 107.

At act 2, NTN node 107 may analyze at least one energy parameter value, resulting from at least one energy parameter measurement corresponding to the NTN node, with respect to the at least one energy saving criterion 510 to result in an analyzed at least one energy parameter value. The energy parameter measurement may be determined by node 107 and may comprise a charge level corresponding to a battery that provides electricity to node 107, a current flow at the node, a voltage level at the node, an energy consumption rate at the node, or a power usage value at the node.

At act 2, based on the analyzed at least one energy parameter value being determined to satisfy the at least one energy saving criterion 510, for example NTN RAN node 107 determining that a battery charge level at the node is equal to or less than a battery charge criterion, the NTN node may determine to delegate paging with respect to at least one NTN paging occasion to another paging occasion, which may be another NTN paging occasion corresponding to the NTN node or which may be a terrestrial paging occasion corresponding to TN RAN node 105. NTN RAN node 107 may determine one or more NTN paging occasions to delegate based on how severe battery charge depletion is or based on how severe an energy consumption rate is. Thus, RAN node 107 may analyze an energy parameter value with respect to multiple energy saving criteria to determine which, and how many, paging occasion(s) are to be delegated. For example, if analysis of a measured energy parameter value with respect to a first energy saving criterion indicates a first level of battery charge depletion the non-terrestrial node may halt, or delegate, paging corresponding to first paging occasion resources, and if analysis of a measured energy parameter value with respect to a second energy saving criterion indicates a second level of battery charge depletion corresponds to more battery charge depletion than is associated with the first level of battery charge depletion, the non-terrestrial node may halt, or delegate, paging corresponding to second paging resource that may correspond to more paging occasion resources then the first paging occasion resources. An example of the at least one energy parameter value being determined to satisfy energy saving criterion 510 may comprise NTN node 107 determining that an energy consumption rate at the NTN node exceeds an energy consumption rate criterion/threshold configured via field 510 in configuration information 305. Another example of the at least one energy parameter value being determined to satisfy the at least one energy saving criterion may comprise NTN node 107 determining that a time slot/period, configured via field 515 in configuration 305, has begun, or will begin soon. Upon determining that an energy saving criterion is satisfied, NTN RAN node 107 may determine one or more NTN paging occasions to be halted such that an energy consumption rate corresponding to the NTN node is likely to fall below rate corresponding to a criterion indicated in field 510 of configuration 305.

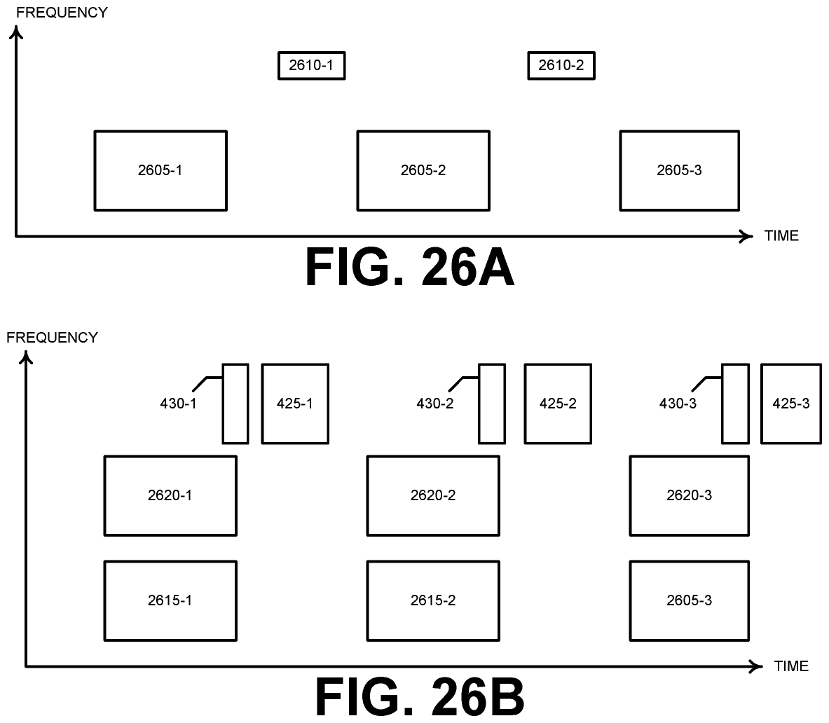

In an embodiment, at act 3, non-terrestrial node 107 may determine, based on a radio parameter measurement report that may comprise a signal strength measurement corresponding to a reference signal broadcast by TN RAN node 105, that UE 115 is not within signal strength range 307, which corresponds to non-terrestrial radio network node 107, that can accommodate the UE reliably receiving paging messages transmitted by TN RAN node 105. Accordingly, at act 4, NTN node 107 may transmit to user equipment 105, which may be configured to receive paging messages transmitted by the non-terrestrial radio network node via at least one first non-terrestrial paging resource, and corresponding at least one first non-terrestrial paging occasion 2605 shown in FIG. 26A, paging modification information message 310 comprising modified paging resource information indicative of at least one second non-terrestrial paging resource and corresponding at least one second non-terrestrial paging occasion 2610. The at least one second non terrestrial paging resource and/or corresponding second non-terrestrial paging occasion(s) 2610 may comprise fewer paging occasions than the at least one first non-terrestrial paging occasion 2605 or fewer/less paging occasion resources than the at least first non-terrestrial paging occasion resource(s) (e.g., a second paging occasion resource 2610 may comprise less frequency resources or less time resources than a first paging occasion resource 2605 as shown in FIG. 26A by paging occasion block 2610 being smaller in duration and smaller in frequency range than paging occasion block 2605). Thus, if non-terrestrial network node 107 shown in FIG. 3 determines that user equipment 115 is too far from terrestrial radio network node 105 to receive paging indications therefrom via terrestrial paging occasions that may temporarily deliver paging indications on behalf of the non-terrestrial network node with respect to non-terrestrial paging occasions 2605 shown in FIG. 26A that the non-terrestrial network node may have halted, or delegated to the terrestrial radio network node, the non-terrestrial network node may activate fewer, or smaller, non-terrestrial paging occasions 2610 such that the user equipment may still receive paging indications from the non-terrestrial network node but the non-terrestrial network node may consume less energy than if a halted, or delegated, ‘full-size’ non-terrestrial paging occasion 2605 were used to deliver paging indications to the user equipment.

Paging modification information message 310 transmitted to user equipment 115 at act 4 may be referred to as a paging override indication message and may comprise indication of new/second paging occasion(s) 2610, and corresponding second resource(s), to be monitored by user equipment, determined to be beyond range 307, during at least one configured non-terrestrial paging occasion 2605 and/or at least one paging occasion delegation period, which may be referred to as a delegated paging period. A user equipment receiving a paging override indication message may receive paging indication messages according to second paging occasions 2610, indicated in the paging modification information message/paging override indication message, during the indicated paging occasion delegation period and may resume monitoring configured first paging occasion resources 2605 after the indicated paging occasion delegation period ends.

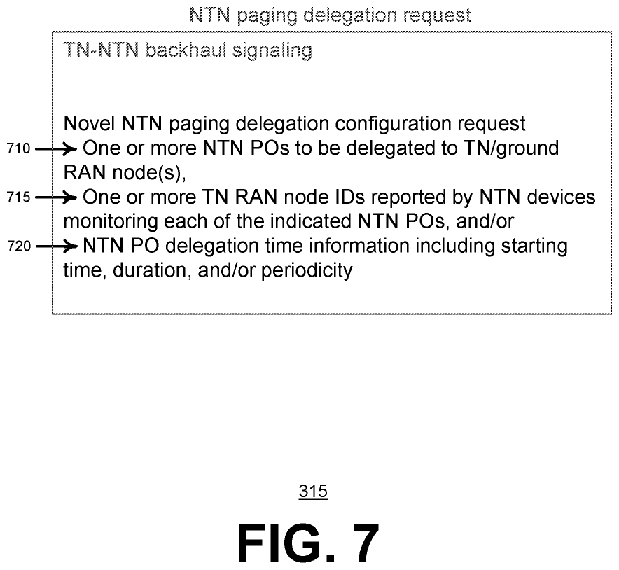

In another embodiment, to facilitate delegation of paging occasions that can deliver paging indication message to user equipment that are not located beyond range 307, NTN RAN node may at act 5 compile and transmit, towards TN RAN node 105, gateway 106, and/or TN-NTN shared core network element 131, paging delegation request 315 requesting that TN RAN node 105 facilitate delivery to user equipment 115 of at least one paging indication message that may be directed to the user equipment. Request 315 may comprise one or more non-terrestrial paging occasion indications (e.g., field 710 shown in FIG. 7) indicative of non-terrestrial paging occasions, for example first paging occasions 2615 shown in FIG. 26B, to be halted by NTN node 107 and delegated to TN/ground RAN node 105. Request 315 may comprise one or more TN RAN node identifiers in field 715 indicative of at least one TN RAN node reported by NTN-capable user equipment devices that have been configured to monitor non-terrestrial paging occasions indicated in field 710. In field 720, request 315 may comprise non terrestrial paging occasion delegation timing information indicative of at least one paging occasion delegation period. The non-terrestrial paging occasion delegation timing information may comprise a starting time, a duration, and/or periodicity corresponding to the at least one paging occasion delegation period. Information in field 715 may facilitate core network 130 and/or TN RAN node 105 shown in FIG. 3 in identifying at least one TN coverage area, for example a tracking area, within which NTN-capable user equipment, configured to monitor delegated non-terrestrial paging occasions indicated in field 710 shown in FIG. 7, is/are located.

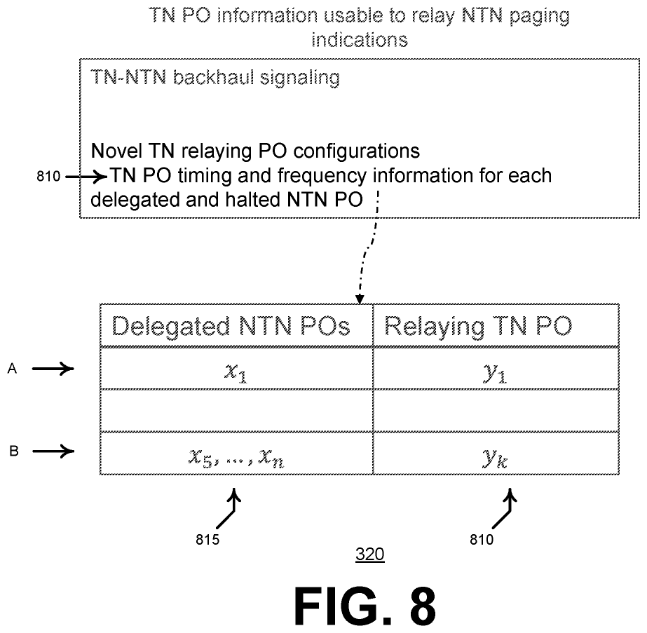

Continuing with description of FIG. 3, responsive to request 315 transmitted by non-terrestrial node 107 at act 5, at act 6, terrestrial radio network node 105 may direct to the non-terrestrial node paging occasion resource delegation message 320. Resource delegation message 320 may comprise at least one delegated paging occasion resource indication indicative of at least one terrestrial paging resource, corresponding to at least one terrestrial paging occasion, to be usable by user equipment 115 to receive paging indication messages directed to the user equipment that would be delivered via non terrestrial node 107 but for the non-terrestrial node having delegated at least one non-terrestrial paging occasion indicated in field 710 of request 315. Paging occasion resource delegation message 320 may comprise modified paging resource information indicative of the at least one terrestrial paging resource or the at least one non-terrestrial paging occasion. Modified paging resource information in message 320 may comprise a delegated paging occasion indication indicative that paging is to be facilitated by the terrestrial radio network node via the at least one terrestrial paging occasion according to the at least one terrestrial paging resource. NTN RAN node 107 may receive paging occasion resource delegation message 320 from TN RAN node 105, gateway 106, and/or TN-NTN shared core network element 131. Paging occasion resource delegation message 320 may comprise terrestrial paging occasion information 810A and 810B, as shown in FIG. 8, indicative of terrestrial paging occasion resources usable to relay paging indications on behalf of NTN node 107 shown in FIG. 3. Message 320 may comprise at least one indication 815 of NTN paging occasion resources, which may have been indicated by NTN RAN node 107 via paging delegation request 315. Associating non-terrestrial paging occasion resource indication(s) 815A and 815B with terrestrial paging occasion resource indications 810A and 810B, respectively, may facilitate non-terrestrial node 107 indicating to UE 115 terrestrial paging occasion resource(s), indicated by indication(s) 810, to be monitored, during a paging delegation period, instead of non-terrestrial paging occasion resource(s) indicated by respective indication(s) 815.

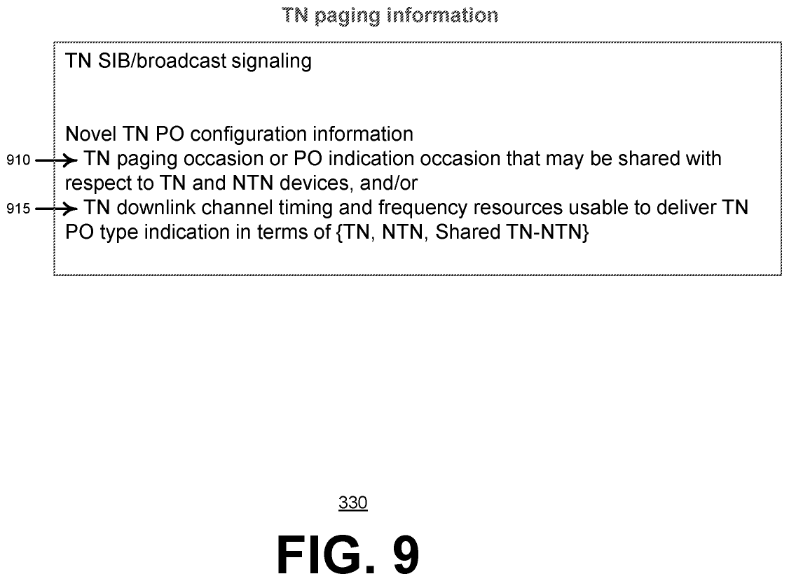

At act 7, TN RAN node 105 may facilitate transmitting, to UE 115, message 330, which may also be referred to as a paging modification information message. (Message 310 transmitted by NTN node 107 to UE 115 at act 4 may also be referred to as a paging modification information message.) Paging modification information message 330 may be transmitted via terrestrial radio link(s) 125 and may comprise, as shown in FIG. 9, at least one terrestrial paging occasion indication in field 910, indicative of at least one paging occasion, which may be shared, or sharable, among terrestrial user equipment (e.g., idle user equipment that may have selected, or camped on, TN RAN node 105) or non-terrestrial user equipment (e.g., idle user equipment that may have selected, or camped on, NTN RAN node 107).

In field 915, message 330 may comprise at least one terrestrial downlink channel timing or frequency resource indication indicative of at least one resource usable to deliver, from TN RAN node 105 to UE 115, a terrestrial paging occasion type. A paging occasion type may be associated with a paging occasion used to deliver paging indication messages only to terrestrial user equipment, only to non-terrestrial user equipment, or to both. Indicating a paging occasion type in field 915 may facilitate reducing paging detection loading at a user equipment that does not correspond to a paging occasion type indicated in field 915. For example, if a paging occasion type indicated in field 915 indicates that a sharable paging occasion resource indicated in field 910 is only usable to deliver paging indication messages to non-terrestrial user equipment, after decoding a paging occasion type occasion indicated by field 915, a terrestrial user equipment may enter a sleep mode and avoid consuming energy and incurring processor loading in attempting to decode the sharable paging occasion resource. Thus, use of paging occasion type occasion resource to indicate a device type to which a paging indication delivered via a sharable paging resource indicated in field 910 is directed, may reduce occurrences of false paging occasion decoding.

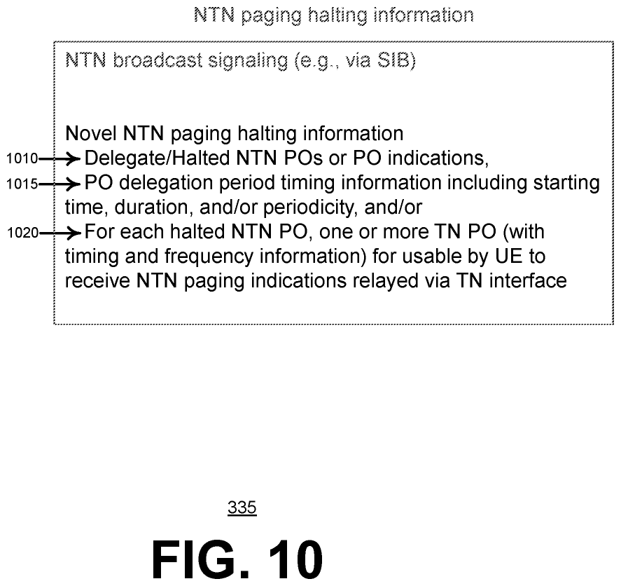

At act 8, non-terrestrial radio network node 107 may facilitate transmitting, to user equipment 115, non-terrestrial network paging halting information message 335. As shown in FIG. 10, message 335 may comprise in field 1010 indication(s) of at least one halted, or delegated, non-terrestrial paging occasion(s) delegated by NTN node 107 to TN node 105 via request 315. In field 1015, message 335 may comprise non-terrestrial delegation period timing information including a starting time of a paging occasion delegation period during which NTN paging occasions are to be delegated by NTN node 105 to terrestrial RAN node 105. Field 1015 in message 335 may comprise a duration of the paging occasion delegation period. Field 1015 in message 335 may comprise a periodicity corresponding to and indicated paging occasion delegation period. Field 1020 of message 335 may comprise, for each of at least one halted non-terrestrial paging occasions indicated in field 1010, at least one terrestrial paging occasion resource indication indicative of at least one timing or frequency resource usable by terrestrial RAN node 105 to relay non terrestrial paging indications via terrestrial interface link(s) during a paging occasion delegation period corresponding to timing information that may be indicated in field 1015. Terrestrial paging occasion resource information included in field 1020 may have been indicated to non-terrestrial network node 107 in field(s) 815 via message 320. Non-terrestrial network node 107 may determine to transmit message 335 after analyzing a measured energy consumption value with respect to an energy saving criterion received via configuration message 305.

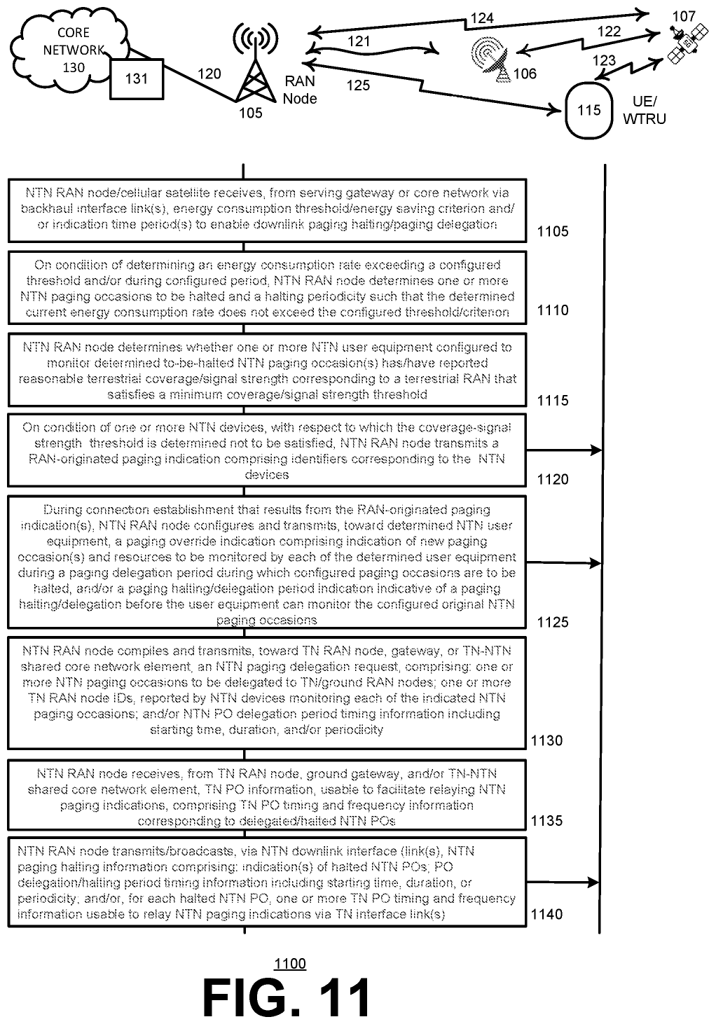

Turning now to FIG. 11, the figure illustrates a timing diagram of an example method 1100. At act 1105, non-terrestrial RAN node/cellular satellite 107 may receive energy saving criterion/criteria, which may comprise thresholds or scheduled time periods for enabling downlink paging halting, from serving gateway 106 or core network 131 via backhaul interface link(s). The energy saving criterion/criteria may be received in an energy saving criterion configuration information message, such as message 305 described in reference to FIG. 3 and shown in FIG. 5. On condition of NTN RAN node 107 determining an energy consumption rate exceeding a configured threshold during an active configured period, the NTN RAN node may determine, at act 1110, one or more NTN paging occasions to be halted and a corresponding halting periodicity such that an energy consumption rate at the NTN node may not exceed a configured criterion. At act 1115, NTN RAN node may determine user equipment 115 as one of one or more NTN user equipment, monitoring the determined to-be-halted NTN paging occasions, and whether the determined NTN user equipment have reported reasonable ground coverage/signal strength that satisfies a minimum pre-configured coverage threshold (e.g., user equipment, shown in FIG. 3, may have previously reported a received TN coverage level from terrestrial RAN node 105 that exceeds a minimum coverage threshold that corresponds to range boundary 307). On condition of UE 115 being determined to have reported one or more user equipment that have previously reported TN RAN coverage levels/signal strength values that do not satisfy a configured coverage level threshold, which user equipment would thus be unlikely to be able to satisfactorily receive paging indications from TN RAN node 105, NTN RAN 107 node may transmit at act 1120 a RAN-originated paging indication, including NTN device identifiers corresponding to the determined user equipment devices.

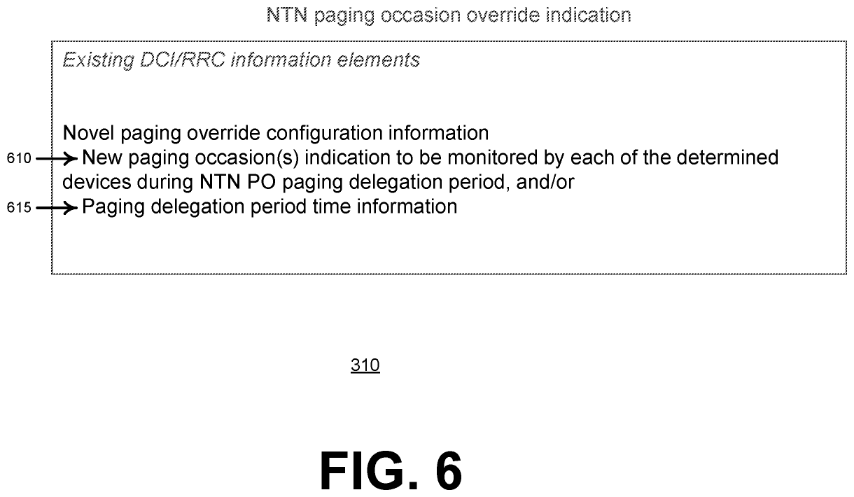

At act 1125, NTN RAN node may transmit and configure, via a paging override indication message, for example message 310 described in reference to FIG. 3 and shown in FIG. 6, to NTN user equipment 115 and other user equipment determined to be outside of, or beyond, a range within which TN RAN 105 can satisfactorily deliver paging indications to the NTN user equipment. The paging override indication message may be transmitted during connection establishment between UE 115 and NTN node 107. The paging override indication message may comprise indication(s) of new non-terrestrial paging occasion(s) to be monitored by each of the user equipment devices that are determined to be located outside of a coverage range corresponding to TN node 105 during an NTN paging occasion delegation period. The paging override indication message may comprise timing information indicative of a paging delegation/halting period before the NTN user equipment are able to monitor previously configured non-terrestrial paging occasions.

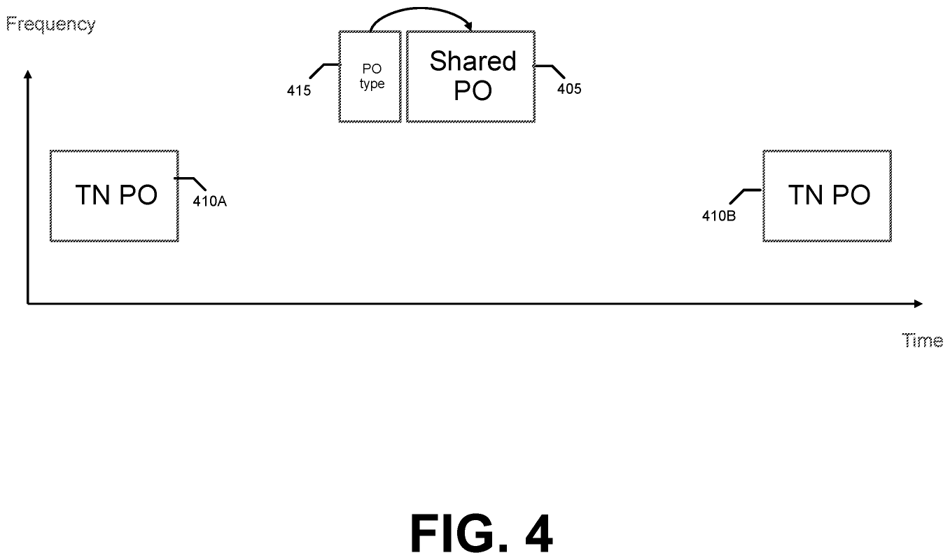

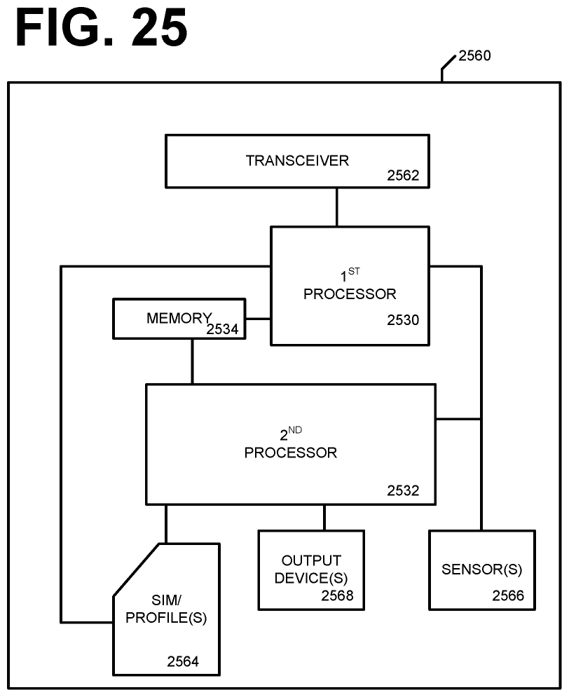

With respect to non-terrestrial user equipment that have been determined to be within a terrestrial coverage level that would likely correspond to satisfactory delivery of paging indications from TN RAN node 105 to the NTN user equipment, at act 1130, NTN RAN 107 node may compile and transmit, toward TN RAN node 107, gateway 106, and/or TN-NTN shared core network element 131, an NTN paging delegation request, for example request 315 described in reference to FIG. 3 and shown in FIG. 7. The paging delegation request may comprise: indication(s) of one or more NTN paging occasions to be delegated to terrestrial RAN nodes; one or more TN RAN node identifiers, reported by NTN user equipment that have been monitoring the indicated NTN paging occasions; or NTN paging occasion delegation period timing information including starting time, duration, and/or periodicity. At act 1135, NTN RAN node 107 may receive, from TN RAN node 105, gateway 106, and/or TN-NTN shared core network element 131, terrestrial paging occasion information (e.g., message 320 described in reference to FIG. 3 and shown in FIG. 8) indicative of paging occasion resources usable to relay, by TN node 105, paging indications directed to non-terrestrial user equipment. The terrestrial paging occasion information received at act 1135 may comprise terrestrial paging occasion information, including paging occasion timing or frequency resource information, corresponding to each delegated/halted NTN paging occasion. At act 1140, NTN RAN node 105 may transmit or broadcast, via NTN downlink radio interface link(s), NTN paging halting information (e.g., information message 330 described in reference to FIG. 3 and shown in FIG. 9. NTN paging halting information may comprise: at least one indication of at least one NTN paging occasion halted by NTN node 107; paging occasion delegation/halting period timing information including starting time, duration, and/or periodicity; and/or, for each delegated/halted NTN paging occasion, at least one indication of at least one terrestrial paging occasion resource (e.g., timing or frequency resource information) usable to relay relaying NTN paging indications via terrestrial radio interface link(s). In an embodiment, the at least one terrestrial paging occasion resource indicated at act 1140 may comprise indication(s) of paging occasion resources 425 or paging occasions type occasion resources 430 as shown in FIG. 4 and FIG. 25B.

### Satellite Paging Relaying Over Terrestrial Networks.

As described in reference to FIG. 3, terrestrial network RAN node 105 may receive delegation request 315 from NTN RAN node 107, NTN gateway 106, or shared core network element 131. For each non-terrestrial paging occasion indicated in request 315 to be delegated, TN RAN node may determine one or more associated tracking area(s), or location area(s), with respect to which to implement paging escalation, or delegation, based on TN RAN node identifiers, indicated in request 315, corresponding to TN RAN nodes with respect to which NTN-capable user equipment, configured to monitor NTN paging occasions indicated in request 315 as being delegated, reported. Accordingly, TN RAN node 105 may determine at least one tracking area based on coverage levels corresponding to an identifier corresponding to the TN node being reported to NTN node 107 by user equipment that is/are configured to monitor and decode at least one non-terrestrial paging occasion indicated in request 315 as an NTN paging occasion to be delegated.

TN RAN node 105 may configure or transmit, toward NTN RAN node 107, NTN gateway 106, and/or shared core network 131, terrestrial paging occasion information via message 320 that the terrestrial node 105 may use to relay NTN paging indication. The terrestrial paging occasion information that may be included in message 320 may comprise terrestrial paging occasion timing and frequency resource information indicated, in message 320, as corresponding to delegated or halted non-terrestrial paging occasion resources indicated by NTN node 107 in request 315.

TN RAN node 105 may transmit, via terrestrial downlink radio interface link(s) 125, paging modification information message 330, shown in FIG. 9. Shared/sharable channel paging occasion resource indication indicated in field 915 may be indicative of a paging occasion type that may be usable to facilitate reduction of paging detection loading at terrestrial and non-terrestrial user equipment devices. For example, if terrestrial paging occasions 2615 shown in FIG. 26B are usable to deliver paging indications directed to terrestrial user equipment, a number of user equipment devices that monitor and blindly decode paging occasions 2615 may be large if paging occasions 2615 are indicated in field 910 of message 330, which would result in wasted power consumption and processor loading at non-terrestrial user equipment that may attempt to blindly decode a paging occasion resource 2615. If terrestrial paging occasions 2620 are indicated in field 910 and are only usable by non-terrestrial user equipment, a terrestrial node that indicates occasions 2620 in field 910 may not be able to use resources 2620 for delivery of downlink paging traffic to terrestrial user equipment.

However, if resources 425-1, for example, are usable as shared paging occasion resources by both terrestrial and non-terrestrial user equipment to receive paging indications and if only a terrestrial paging indication (directed to only terrestrial user equipment) is received at a TN RAN node 105 that is facilitating resources 425, a type indication indicated by occasion type resource indication resources 430-1 may be indictive of the paging indication being directed only to terrestrial user equipment. Thus, an idle non-terrestrial user equipment may wake up, decode resources 430-1, determine that a paging indication to be delivered via occasions resources 425-1 is directed to a terrestrial user equipment, and go back to sleep without attempting to decode resources 425-1. Accordingly, a paging occasion type indication indicated by type occasion resources 430 may be used to proactively indicate whether a paging occasion 425 comprises one or more paging indications directed to a terrestrial user equipment, a non-terrestrial user equipment, or both, which may facilitate avoiding, or reducing, occurrences of false paging occasion decoding by user equipment devices.

After receiving a paging indication directed to a non-terrestrial user equipment that is to be transmitted by NTN node 107 according to a non-terrestrial paging occasion 710, indicated by request 315, that has been halted, or delegated, by the NTN node during a paging occasion delegation period, which may also be indicated by request 315, TN RAN node 105 may determine and indicate in field 810 of message 320 at least one terrestrial paging indication that is associated with the halted/delegated non-terrestrial paging occasion indicated in request 315. TN RAN node 105 may transmit a non-terrestrial paging occasion indication and/or a shared paging occasion type indication via downlink interface link(s) 125 to the user equipment being paged before the determined terrestrial paging occasion to be used to transmit the paging indication. Terrestrial RAN node 105 may transmit/relay the non-terrestrial paging indication directed to the at least one non-terrestrial user equipment according to the determined terrestrial paging occasion, which may be a shared/sharable paging occasion.

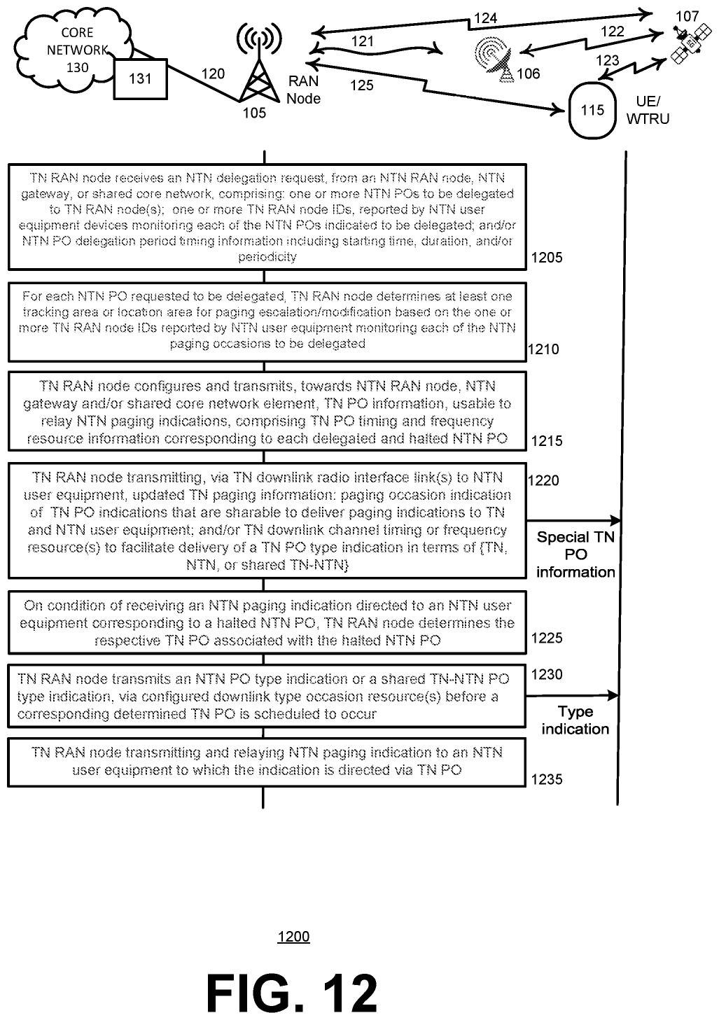

Turning now to FIG. 12, the figure illustrates a timing diagram of a method 1200. At act 1205, terrestrial RAN node 105 may receive an NTN delegation request, (e.g., request 315) from NTN RAN node 107, NTN gateway 106, or shared core network entity 131. For each indicated NTN paging occasion indicated to be delegated in the request received at 1205, at act 1210 TN RAN node 107 may determine at least one tracking area with respect to which paging escalation/facilitating delivery of NTN paging occasions is to be implemented, based on at least one TN RAN node identifier indicated in the request received at act 1205 corresponding to at least one TN RAN node reported by at least one NTN user equipment monitoring the NTN paging occasions, indicated in the request received at act 1205, to be delegated.

At act 1215, TN RAN node 105 may transmit, toward NTN RAN node 107, NTN gateway 106, and/or shared core network element 131, terrestrial paging occasion information usable to relay NTN paging indications. The terrestrial paging occasion information may comprise terrestrial paging occasion timing and frequency resource information (e.g., information delivered via message 320 described in reference to FIG. 3 and shown in FIG. 8) indicative of at least one terrestrial paging occasion corresponding to each delegated and halted non-terrestrial paging occasion indicated in the request received at 1205. At act, 1220, TN RAN node 105 may transmit, via terrestrial downlink radio interface link(s) 125, updated TN paging information comprising at least one indication of at least one sharable terrestrial paging occasion resource that may be sharable among terrestrial user equipment that have selected TN RAN node 105 and non-terrestrial user equipment that have selected NTN RAN node 107. The updated TN paging information transmitted at act 1220 may comprise at least one indication of at least one terrestrial downlink channel timing or frequency resource usable to deliver a terrestrial paging occasion type indication (e.g., type indication resource 430 shown in FIG. 4) indicative of a paging occasion type corresponding to the sharable paging occasion resource (e.g., the type indication may be indicative of the sharable paging occasion resource being usable to facilitate terrestrial paging indications only, non-terrestrial paging indications only, or that the sharable paging occasion resource may be used to deliver paging indications to both terrestrial and non-terrestrial user equipment).

On condition of receiving an NTN paging indication, directed to an NTN device configured to monitor a halted delegated non-terrestrial paging occasion, TN RAN node 105 may determine, at act 1225, a terrestrial paging occasion associated with the halted non-terrestrial paging occasion (e.g., a terrestrial paging occasion resource indicated as being associated with the delegated/halted non-terrestrial paging occasion in message 320). At act 1230, TN RAN node 105 may transmit to UE 115 a non-terrestrial only paging occasion type indication or a shared terrestrial/non-terrestrial paging occasion type indication, via a configured occasion type occasion (e.g., occasion resource 430 shown in FIG. 4) before the corresponding terrestrial paging occasion (e.g., before occasion 425). At act 1230, TN RAN node 105 may transmit/relay the NTN paging indication received at act 1225 to intended NTN UE 115 via the terrestrial paging occasion (e.g., via occasion 425 shown in FIG. 4).

### Adaptive Device Paging Detection.

In reference to FIG. 3, NTN-capable user equipment WTRU/device 115 may receive a RAN-originated (e.g., not received by NTN node 107 from core network 130) paging indication from NTN RAN node 107 that has been selected by the user equipment. UE 115 may transmit an NTN connection establishment request toward selected NTN RAN node 107. If NTN node 107 determines that UE 115 is a greater distance from TN node 105 than range boundary 307, while connected with node 107 and operating in an active mode UE 115 may receive, from NTN RAN node 107, a paging override indication 310 that may comprise at least one non-terrestrial paging occasion indication indicative of at least one non-terrestrial PO indication to be monitored during an indicated paging occasion delegation period. Responsive to override indication 310, UE 11 may override a configured paging occasion, monitor, and blindly decode the updated temporary non-terrestrial paging occasion indicated in field 610 of message 310. An overriding paging occasion indicated in field 610 may be smaller than a configured overridden paging occasion that the user equipment is configured to monitor other than during the paging delegation period (e.g., a paging non-delegation period) such that even if NTN node 107 facilitates paging of UE 115, the NTN node may nevertheless reduce power consumption in facilitating paging of the UE. Accordingly, non-terrestrial user equipment that may be out of reach of terrestrial coverage corresponding to TN node 105 may be paged by NTN node 107 while the NTN node reduces power consumed in facilitating paging of UE 115.

On condition of non-terrestrial UE 115 receiving, from selected NTN RAN node 107, NTN paging halting information in message 335, which may be transmitted by NTN node to UE 115 if the UE is within range 307 with respect to TN RAN node 105, UE 115 may adjust transceiver circuitry to receive paging indications via resources indicated as usable to detect NTN paging indications during a paging delegation period. Non-terrestrial UE 115 may receive paging modification information that may comprise at least one terrestrial paging occasion indication indicative of at least one paging occasion resource that is to be shared among terrestrial and non-terrestrial user equipment and/or at least one terrestrial downlink channel timing and frequency resource indication indicative of at least one occasion resource usable to indicate a paging occasion type corresponding to the shared/sharable paging occasion resource.

On condition of detecting a paging occasion type indication indicative of a shared paging occasion resource being usable by terrestrial and non-terrestrial user equipment, non-terrestrial user equipment 115 may monitor and blindly decode the indicated terrestrial paging occasion resource. On condition of detecting, via the decoded terrestrial paging occasion, a paging indication 340 directed to non-terrestrial user equipment 115 during a paging delegation period, the non-terrestrial user equipment may trigger and transmit an uplink connection establishment request to NTN node 107 via NTN interface link(s) 123. On condition of a paging delegation period expiring based on paging delegation period information indicated at least via message 335, non-terrestrial user equipment may switch back to monitoring configured non-terrestrial paging occasions via NTN interface link(s) 123.

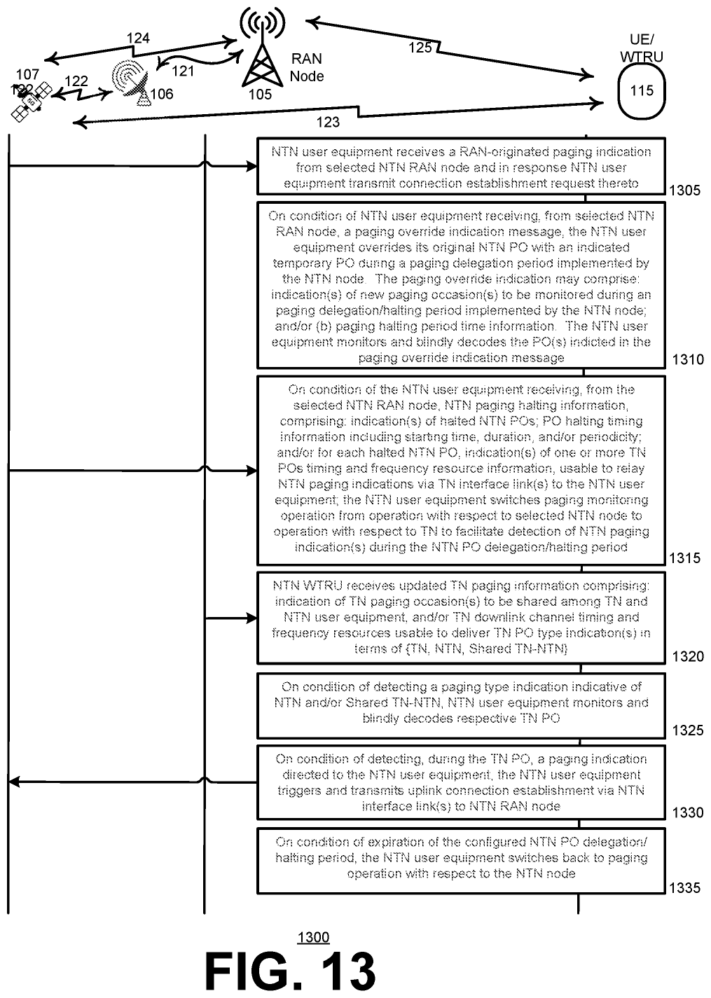

Turning now to FIG. 13, the figure illustrates a timing diagram of a method 1300. At act 1305, non-terrestrial-network-capable user equipment 115 may receive a RAN-originated paging indication from NTN RAN node 107 that UE 115 may have selected. Responsive to the request received at act 105, NTN UE 115 may transmit an NTN connection establishment request to selected NTN RAN node 107. At act 1310, on condition of UE 115 receiving, from selected NTN RAN node 107, a paging override indication (e.g., indication message 310) UE 115 may override monitoring of a previously configured non-terrestrial paging occasion and instead monitor and blindly decode a temporary non-terrestrial paging occasion indicated in the paging override indication message during a non-terrestrial paging occasion delegation period indicated in the paging override indication message.

At act 1315, if NTN node 107 has determined that UE 105 is sufficiently close to terrestrial RAN node 105 to reliably receive paging indications therefrom, NTN UE 115 may receive from NTN node 107, which UE 115 may have selected, non-terrestrial paging occasion halting information (e.g., message 335 described in reference to FIG. 3 and shown in FIG. 10). NTN UE may switch from monitoring of non-terrestrial paging occasions with respect to NTN node 107 to monitoring terrestrial paging occasions with respect to TN node 105 for paging indications during a non-terrestrial paging/halting period indicated in message 335. At act 1320, NTN UE 115 may receive, from TN RAN node 105, updated terrestrial paging occasion information (e.g., message 330 described in reference to FIG. 3 and shown in FIG. 9) indicative of at least one sharable terrestrial paging occasion resource usable to deliver paging indications to terrestrial and non-terrestrial user equipment, or terrestrial downlink channel timing and frequency resources usable to deliver terrestrial paging occasion type indications indicative of whether a paging indication transmitted via the shareable paging occasion resource comprises a paging indicated directed to only a terrestrial user equipment, directed to only a non-terrestrial user equipment, or directed to both of a terrestrial user equipment and a non-terrestrial user equipment. At act 1325, on condition of detecting a paging type indication indicative of a paging indication directed to a non-terrestrial user equipment or to both a terrestrial user equipment and a non-terrestrial user equipment, non-terrestrial UE 115 may monitor and blindly decode the terrestrial paging occasion corresponding to the paging occasion type indication. At act 1330, responsive to detecting a paging indication directed to non-terrestrial UE 115 during the terrestrial paging occasion, the non-terrestrial UE may transmit an uplink connection establishment request to NTN node 107 via NTN interface link(s) 123. At act 1335, on condition of expiration of a non-terrestrial paging occasion delegation period, non-terrestrial user equipment 115 may switch back to monitoring non-terrestrial paging occasions via non-terrestrial interface link(s) 123.

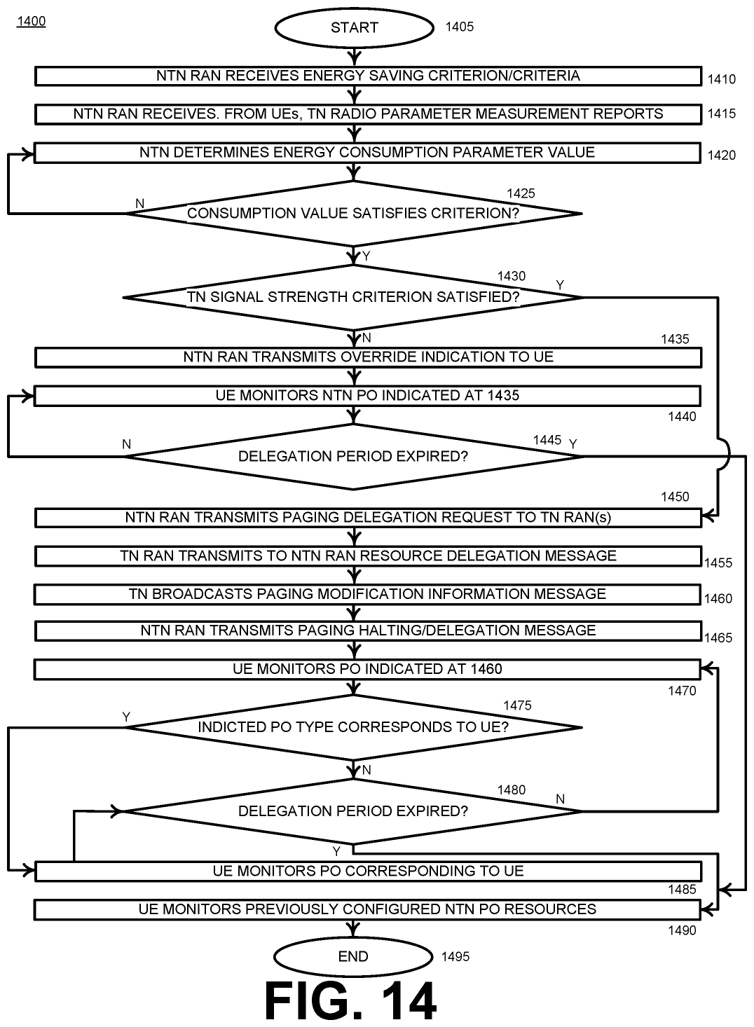

Turning now to FIG. 14, the figure illustrates a flow diagram of an example method 1400. Method 1400 begins at act 1405. At act 1410, a non-terrestrial radio network node may receive energy saving criterion/criteria from a terrestrial radio node, from a core network element, or from a shared core network element that facilitates interoperation between the non-terrestrial radio node and a terrestrial radio network node. At act 1415, the non-terrestrial radio network node may receive from one or more user equipment radio parameter measurement reports indicative of signal strength measurements corresponding to reference signals transmitted or broadcast by one or more terrestrial radio network nodes. At act 1420, the non-terrestrial network node may determine an energy consumption parameter value, for example an energy consumption rate, corresponding to the non-terrestrial network node. The determined energy consumption parameter value may be based on a voltage measurement, a current measurement, a battery charge level, and the like. At act 1425, the non-terrestrial network node may determine whether the determined energy consumption parameter value satisfies an energy saving criterion received at act 1410. If a determination made at act 1425 is that an energy consumption parameter value determined at act 1420 does not satisfy an energy saving criterion, method 1400 may return to act 1420.

If a determination is made at act 1425 that a determined energy consumption parameter value satisfies an energy saving criterion received at act 1410, method 1400 advances to act 1430. At act 1430, the non-terrestrial network node may determine whether at least one signal strength measurement received in a report at act 1415 satisfies a terrestrial signal strength criterion, which may be referred to as a node paging delegation criterion and which may be received at act 1410 or which may be received separately from energy saving criteria received at act 1410. The at least one signal strength measurement analyzed with respect to a signal strength criterion at act 1430 may have been received from at least one user equipment that has been configured to monitor non terrestrial paging occasions corresponding to the non-terrestrial network node. The at least one user equipment may have been configured to monitor the non-terrestrial paging occasion(s) corresponding to the non-terrestrial network node during selection of the non-terrestrial network node by the user equipment or during an established connection between the user equipment and the non-terrestrial network node.

If the non-terrestrial network node determines at act 1430 that a signal strength corresponding to the at least one user equipment does not satisfy a configured terrestrial signal strength criterion, at act 1435 the nontrivial network node may transmit a paging occasion override indication to the at least one user equipment. The paging occasion override indication transmitted at act 1435 may be indicative to the at least one user equipment that the non-terrestrial network node has delegated paging according to at least one non-terrestrial paging occasion, with respect to which the at least one user equipment has been configured to monitor, to another at least one non-terrestrial paging occasion. The other at least one non-terrestrial paging occasion may be shorter in duration, smaller in frequency range, or less frequently occurring than the non-terrestrial paging occasion(s) that the at least one user equipment has been configured to monitor. The paging occasion override indication transmitted at act 1435 may be indicative of a paging delegation period during which the at least one user equipment is to monitor non-terrestrial paging occasion(s) indicated in the paging occasion override indication instead of monitoring one or more previously configured non-terrestrial paging occasion(s). At act 1440, the at least one user equipment may monitor one or more non-terrestrial network paging occasions indicated in the override indication transmitted it act 1435. If a user equipment monitoring a non-terrestrial network paging occasion at act 1440 determines that a paging indication indicated in a paging occasion monitored at act 1445 is directed to the user equipment, the user equipment may transmit from an idle mode to a connected mode with the non-terrestrial network node. At act 1445, the at least one user equipment may determine whether a paging occasion delegation period indicated in the override indication transmitted at act 1435 has expired. If a determination is made at act 1445 that a paging occasion delegation period has not expired, method 1400 returns to act 1440 and the at least one user equipment continues to monitor one or more non-terrestrial network paging occasions indicated in the override indication transmitted by the non-terrestrial radio network node at act 1435. If a determination is made at act 1445 that a delegation period indicated in the override indication transmitted at act 1435 has expired, method 1400 advances to act 1490 and resumes monitoring previously configured non-terrestrial network paging occasion resources. Method 1400 advances to act 1495 and ends.

Returning to description of act 1430, if the non-terrestrial network node determines that at least one terrestrial signal strength measurement received in a radio parameter measurement report at act 1415 satisfies a terrestrial signal strength criterion, method 1400 may advance to act 1450. At act 1450, the non-terrestrial network node may transmit a paging delegation request to at least one terrestrial radio network node corresponding to the at least one terrestrial signal strength measurement received at act 1415. The paging delegation request may comprise identifiers corresponding to the at least one terrestrial radio network node that corresponds to the at least one terrestrial signal strength measurement received at act 1415. The paging delegation request may comprise indication(s) of one or more non terrestrial paging occasions that the non-terrestrial network node has determined to halt, or cease facilitating, during a paging occasion delegation indicated in the paging delegation request. The paging delegation request may comprise a request that at least one terrestrial radio network node, identified in the paging delegation request, facilitate paging with request to the halted non-terrestrial paging occasions.

Responsive to the paging delegation request transmitted by the non-terrestrial network node at act 1440, at act 1455, at least one terrestrial radio network node may transmit to the non-terrestrial radio network node a resources delegation message, for example message 320 described in reference to FIG. 3 and shown in FIG. 8. The resources delegation message may comprise at least one indication of at least one terrestrial paging occasion resource corresponding to at least one non-terrestrial paging occasion resource indicated in the paging delegation request. For example, if a paging delegation request indicates that the non-terrestrial network node is to halt operation with respect to non-terrestrial paging occasion x₁ during a paging delegation period, the resource(s) delegation message transmitted by the terrestrial radio network node at act 1455 may indicate that the terrestrial node may facilitate transmission/broadcasting of paging indications directed to non-terrestrial user equipment, which may be configured to monitor non-terrestrial paging occasion x₁, according to terrestrial paging occasion(s) y₁ as shown in FIG. 8.

At act 1460, as shown in FIG. 14, the terrestrial radio network node may broadcast a paging modification information message, such as, for example message 330 described in reference to FIG. 3 and shown in FIG. 9. The paging modification information message transmitted/broadcast at act 1460 may comprise at least one indication of at least one terrestrial paging occasion that may be usable by at least one non-terrestrial user equipment, previously configured to monitor a non-terrestrial paging occasion that the paging delegation request indicated as being halted by the non-terrestrial network node, to monitor and receive paging indications instead of monitoring the halted non-terrestrial paging occasion during a paging delegation period. The paging modification information message transmitted/broadcast at act 1460 may comprise a paging occasion type occasion indication indicative of a paging occasion type occasion resource usable by at least one user equipment to determine whether a paging occasion corresponding to the page occasion type occasion indication comprises a paging indication directed to a terrestrial user equipment, a non-terrestrial user equipment, or to both terrestrial and non-terrestrial user equipment. The paging occasion type occasion indication may correspond to a non-terrestrial paging occasion indicated in a resources delegation message transmitted at act 1455. A paging occasion type occasion may comprise a shorter duration or a smaller frequency range than a paging occasion that the terrestrial network node may use to deliver an actual paging indication.

At act 1465, the non-terrestrial network node may transmit to at least one non-terrestrial user equipment a paging halting, or a paging delegation, message (e.g., message 335 described in reference to FIG. 3 and shown in FIG. 10) indicative to the at least one non-terrestrial user equipment that the non-terrestrial network node has ceased, or is scheduled to, cease, facilitation of, during a paging delegation period, paging with respect to at least one non-terrestrial paging occasion that the at least one non-terrestrial user equipment is configured to monitor. The message transmitted at act 1465 may comprise an indication of at least one terrestrial paging occasion that the at least one non terrestrial user equipment may monitor to receive paging indications instead of monitoring the at least one non-terrestrial paging occasion with respect to which the message indicates that the non-terrestrial network node has halted or is soon to halt.

At act 1470, at least one non-terrestrial user equipment may monitor a terrestrial paging occasion indicated by the message transmitted at act 1465. The terrestrial paging occasion monitored at act 1470 may comprise a paging indication directed to the at least one non-terrestrial user equipment or a paging occasion type indication.

If the at least one non terrestrial user equipment receives, in a paging modification indication message transmitted/broadcast at act 1460, a paging occasion type occasion indication, the terrestrial paging occasion monitored at act 1470 may be a paging occasion type occasion. At act 1475, the at least one non-terrestrial user equipment may determine whether a paging occasion type occasion monitored at act 1470 comprises a paging occasion type indication that corresponds to the user equipment. If the at least one non-terrestrial user equipment determines that a paging occasion type occasion does not indicate a paging indication type corresponding to the at least one non-terrestrial user equipment (e.g., the paging indication type does not indicate that a paging indication corresponds to a non-terrestrial user equipment or to both a non-terrestrial and a terrestrial user equipment) the at least one non-terrestrial user equipment may determine at act 1480 whether a paging occasion delegation period indicated in a paging halting/delegation message transmitted act 1465 has expired. If the paging occasion delegation period has not expired, method 1400 may return to act 1470 and the at least one non-terrestrial user equipment may continue to monitor terrestrial paging occasions indicated at act 1460. If a determination is made at act 1480 that a paging occasion delegation period indicated in a paging halting/delegation message transmitted at act 1465 has expired, method 1400 advances to act 1490. The at least one non-terrestrial user equipment may revert to monitoring one or more previously configured non-terrestrial paging occasions and method 1400 advances to act 1495 and ends.

Returning to description of act 1475, if the at least one non-terrestrial user equipment determines that a paging occasion type occasion (e.g., terrestrial occasion 430 shown in FIG. 4) comprises a paging occasion type indication indicative of a paging occasion type corresponding to the at least one non terrestrial network node equipment (e.g., the paging indication type comprises a paging occasion type indication indicative that a paging indication delivered via terrestrial paging occasion 425 corresponds to a non-terrestrial user equipment or both a non-terrestrial and a terrestrial user equipment), the at least one user equipment may monitor at act 1485 a terrestrial paging occasion (e.g., occasion 425) corresponding to the paging occasion type occasion (e.g., occasion 430). Responsive to a paging indication delivered via a terrestrial paging occasion, the at least one non terrestrial user equipment may perform a network operation, for example, establishing a connection with the non-terrestrial network node if the paging indication is directed to the at least one user equipment. If the paging indication monitored at act 1485 is not directed to the at least one non-terrestrial user equipment, the at least one non-terrestrial user equipment may advance to act 1480 and determine whether a paging occasion delegation period indicated in a paging halting/delegation message has expired. If the paging occasion delegation period has not expired, the at least one user equipment may return to act 1470 and continue monitoring terrestrial paging occasions indicated at act 1460. If the non-terrestrial network node determines that a paging occasion delegation period has expired, the at least one non-terrestrial user equipment may resume monitoring previously configured non-terrestrial network paging occasion resources at act 1490. Method 1400 advances to act 1495 and ends.

The at least one user equipment may use a paging occasion type indication indicated via a paging occasion type occasion to determine whether to monitor a larger paging occasion (e.g., the paging occasion may be larger than the paging occasion type occasion). If the at least one non-terrestrial user equipment does not receive a paging occasion type occasion indication in field 915 of a paging modification information message transmitted/broadcast at act 1460, the at least one non terrestrial user equipment may monitor and blindly decode a paging occasion indicated by information in field 910 of message 330 for presence of a paging indication directed to the user equipment.

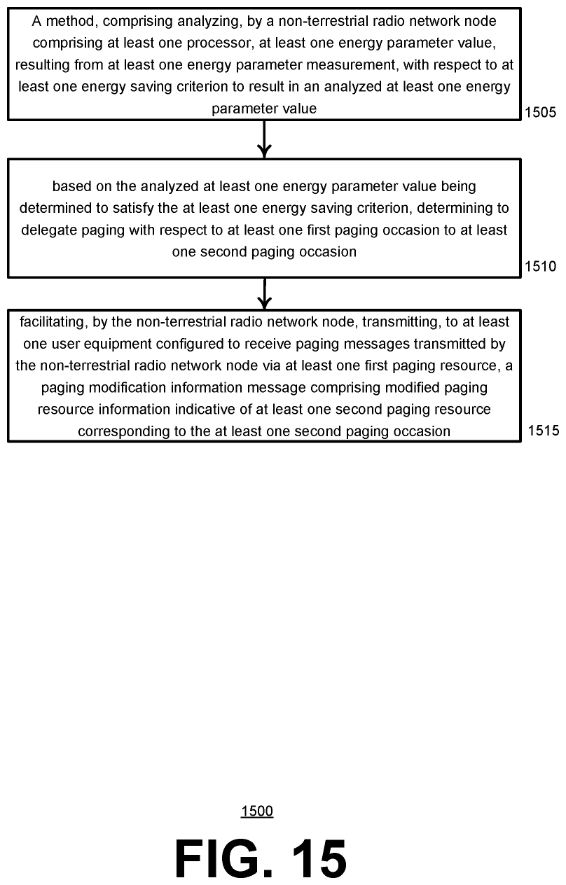

Turning now to FIG. 15, the figure illustrates an example embodiment method 1500 comprising at block 1505 analyzing, by a non-terrestrial radio network node comprising at least one processor, at least one energy parameter value, resulting from at least one energy parameter measurement, with respect to at least one energy saving criterion to result in an analyzed at least one energy parameter value; at block 1510 based on the analyzed at least one energy parameter value being determined to satisfy the at least one energy saving criterion, determining to delegate paging with respect to at least one first paging occasion to at least one second paging occasion; and at block 1515 facilitating, by the non-terrestrial radio network node, transmitting, to at least one user equipment configured to receive paging messages transmitted by the non-terrestrial radio network node via at least one first paging resource, a paging modification information message comprising modified paging resource information indicative of at least one second paging resource corresponding to the at least one second paging occasion.

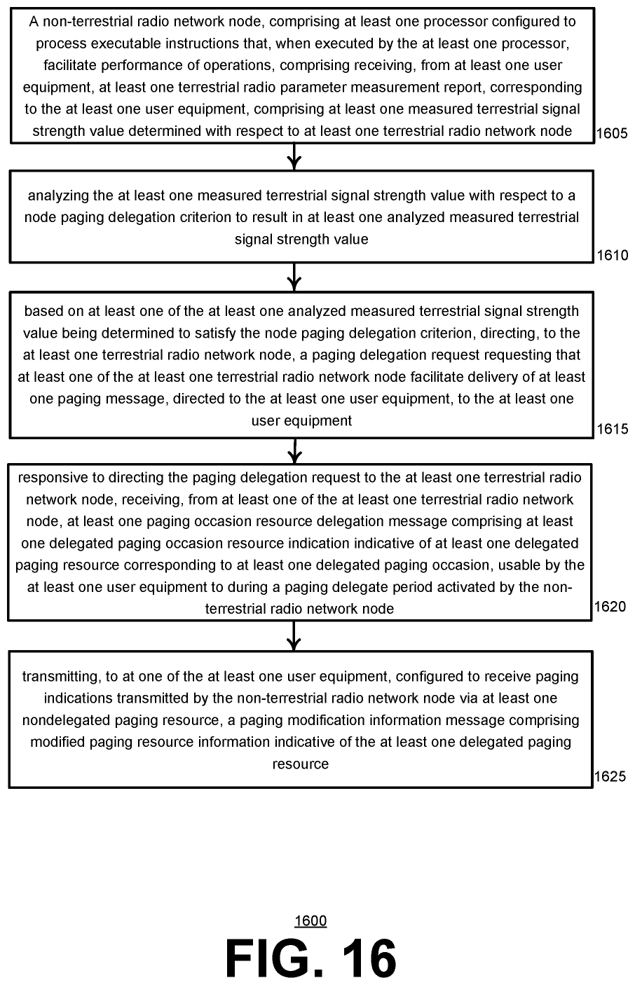

Turning now to FIG. 16, the figure illustrates a non-terrestrial radio network node 1600, comprising at block 1605 at least one processor configured to process executable instructions that, when executed by the at least one processor, facilitate performance of operations, comprising receiving, from at least one user equipment, at least one terrestrial radio parameter measurement report, corresponding to the at least one user equipment, comprising at least one measured terrestrial signal strength value determined with respect to at least one terrestrial radio network node; at block 1610 analyzing the at least one measured terrestrial signal strength value with respect to a node paging delegation criterion to result in at least one analyzed measured terrestrial signal strength value; at block 1615 based on at least one of the at least one analyzed measured terrestrial signal strength value being determined to satisfy the node paging delegation criterion, directing, to the at least one terrestrial radio network node, a paging delegation request requesting that at least one of the at least one terrestrial radio network node facilitate delivery of at least one paging message, directed to the at least one user equipment, to the at least one user equipment; at block 1620 responsive to directing the paging delegation request to the at least one terrestrial radio network node, receiving, from at least one of the at least one terrestrial radio network node, at least one paging occasion resource delegation message comprising at least one delegated paging occasion resource indication indicative of at least one delegated paging resource corresponding to at least one delegated paging occasion, usable by the at least one user equipment to during a paging delegate period activated by the non-terrestrial radio network node; and at block 1625 transmitting, to at one of the at least one user equipment, configured to receive paging indications transmitted by the non-terrestrial radio network node via at least one nondelegated paging resource, a paging modification information message comprising modified paging resource information indicative of the at least one delegated paging resource.

Turning now to FIG. 17 the figure illustrates a non-transitory machine-readable medium 1700 comprising at block 1705 executable instructions that, when executed by at least one processor of a terrestrial radio network node, facilitate performance of operations, comprising receiving, from at least one user equipment, at least one terrestrial radio parameter measurement report, corresponding to the at least one user equipment, comprising at least one measured terrestrial signal strength value determined with respect to at least one terrestrial radio network node; at block 1710 analyzing the at least one measured terrestrial signal strength value with respect to a node paging delegation criterion to result in at least one analyzed measured terrestrial signal strength value; and at block 1715 based on at least one of the at least one analyzed measured terrestrial signal strength value being determined to fail to satisfy the node paging delegation criterion, transmitting a paging modification information message to at least one of the at least one user equipment corresponding to the at least one of the at least one analyzed measured terrestrial signal strength value being determined to fail to satisfy the node paging delegation criterion, wherein the paging modification information message comprises a non-terrestrial network resource indication indicative of at least one delegated non-terrestrial network paging resource, corresponding to the non-terrestrial radio network node, usable by the at least one of the at least one user equipment to receive paging indications during a delegated paging period, and wherein the at least one of the at least one user equipment is configured to use at least one nondelegated non-terrestrial network paging resource during a nondelegated paging period.

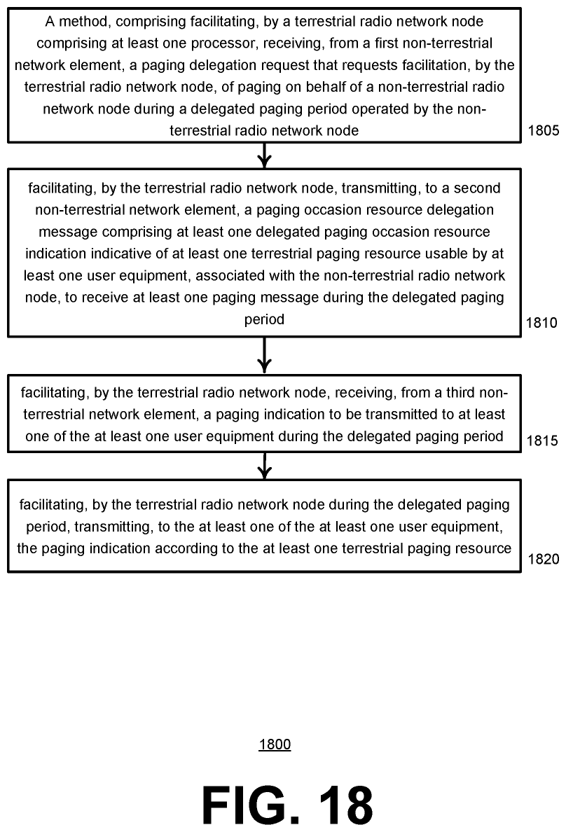

Turning now to FIG. 18, the figure illustrates an example embodiment method 1800 comprising, at block 1805, facilitating, by a terrestrial radio network node comprising at least one processor, receiving, from a first non-terrestrial network element, a paging delegation request that requests facilitation, by the terrestrial radio network node, of paging on behalf of a non-terrestrial radio network node during a delegated paging period operated by the non-terrestrial radio network node; at block 1810 facilitating, by the terrestrial radio network node, transmitting, to a second non-terrestrial network element, a paging occasion resource delegation message comprising at least one delegated paging occasion resource indication indicative of at least one terrestrial paging resource usable by at least one user equipment, associated with the non-terrestrial radio network node, to receive at least one paging message during the delegated paging period; at block 1815 facilitating, by the terrestrial radio network node, receiving, from a third non-terrestrial network element, a paging indication to be transmitted to at least one of the at least one user equipment during the delegated paging period; and at block 1820 facilitating, by the terrestrial radio network node during the delegated paging period, transmitting, to the at least one of the at least one user equipment, the paging indication according to the at least one terrestrial paging resource.

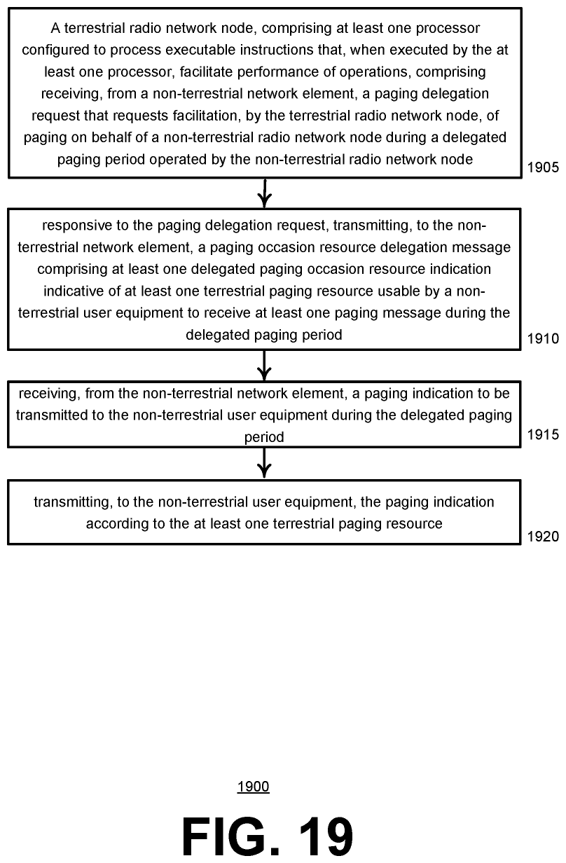

Turning now to FIG. 19, the figure illustrates an example terrestrial radio network node 1900, comprising at block 1905 at least one processor configured to process executable instructions that, when executed by the at least one processor, facilitate performance of operations, receiving, from a non-terrestrial network element, a paging delegation request that requests facilitation, by the terrestrial radio network node, of paging on behalf of a non-terrestrial radio network node during a delegated paging period operated by the non-terrestrial radio network node; at block 1910 responsive to the paging delegation request, transmitting, to the non-terrestrial network element, a paging occasion resource delegation message comprising at least one delegated paging occasion resource indication indicative of at least one terrestrial paging resource usable by a non-terrestrial user equipment to receive at least one paging message during the delegated paging period; at block 1915 receiving, from the non-terrestrial network element, a paging indication to be transmitted to the non-terrestrial user equipment during the delegated paging period; and at block 1920 transmitting, to the non-terrestrial user equipment, the paging indication according to the at least one terrestrial paging resource.

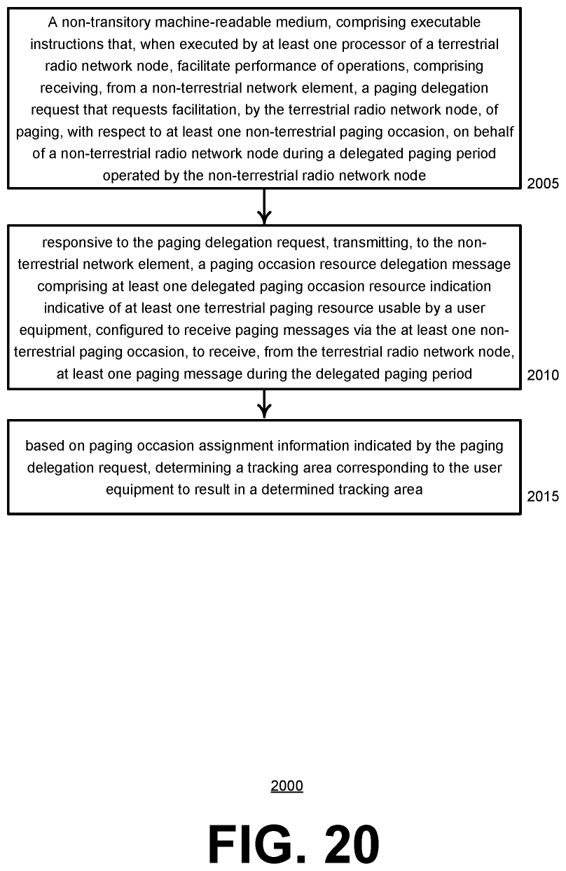

Turning now to FIG. 20, the figure illustrates a non-transitory machine-readable medium 2000 comprising at block 2005 executable instructions that, when executed by at least one processor of a terrestrial radio network node, facilitate performance of operations, comprising receiving, from a non-terrestrial network element, a paging delegation request that requests facilitation, by the terrestrial radio network node, of paging, with respect to at least one non-terrestrial paging occasion, on behalf of a non-terrestrial radio network node during a delegated paging period operated by the non-terrestrial radio network node; at block 2010 responsive to the paging delegation request, transmitting, to the non-terrestrial network element, a paging occasion resource delegation message comprising at least one delegated paging occasion resource indication indicative of at least one terrestrial paging resource usable by a user equipment, configured to receive paging messages via the at least one non-terrestrial paging occasion, to receive, from the terrestrial radio network node, at least one paging message during the delegated paging period; and at block 2015 based on paging occasion assignment information indicated by the paging delegation request, determining a tracking area corresponding to the user equipment to result in a determined tracking area.

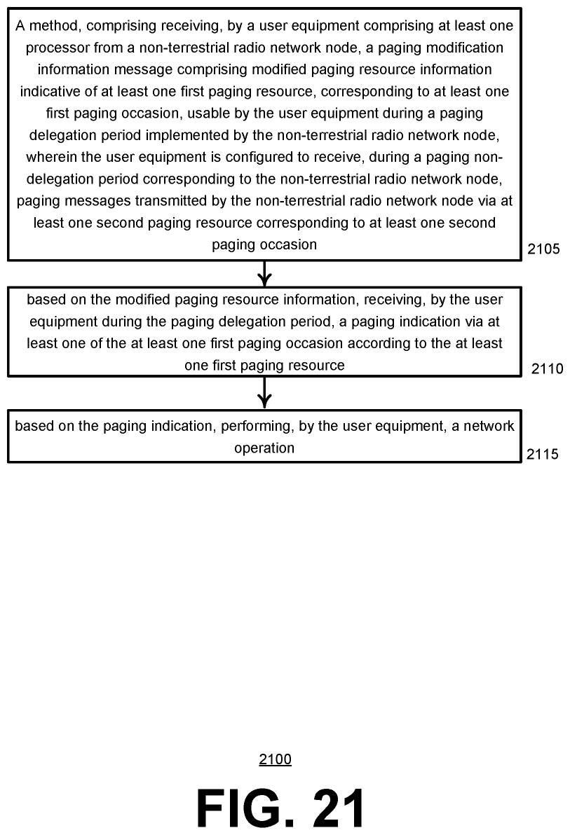

Turning now to FIG. 21, the figure illustrates an example embodiment method 2100 comprising, at block 2105, receiving, by a user equipment comprising at least one processor from a non-terrestrial radio network node, a paging modification information message comprising modified paging resource information indicative of at least one first paging resource, corresponding to at least one first paging occasion, usable by the user equipment during a paging delegation period implemented by the non-terrestrial radio network node, wherein the user equipment is configured to receive, during a paging non-delegation period corresponding to the non-terrestrial radio network node, paging messages transmitted by the non-terrestrial radio network node via at least one second paging resource corresponding to at least one second paging occasion; at block 2110 based on the modified paging resource information, receiving, by the user equipment during the paging delegation period, a paging indication via at least one of the at least one first paging occasion according to the at least one first paging resource; and at block 2115 based on the paging indication, performing, by the user equipment, a network operation.

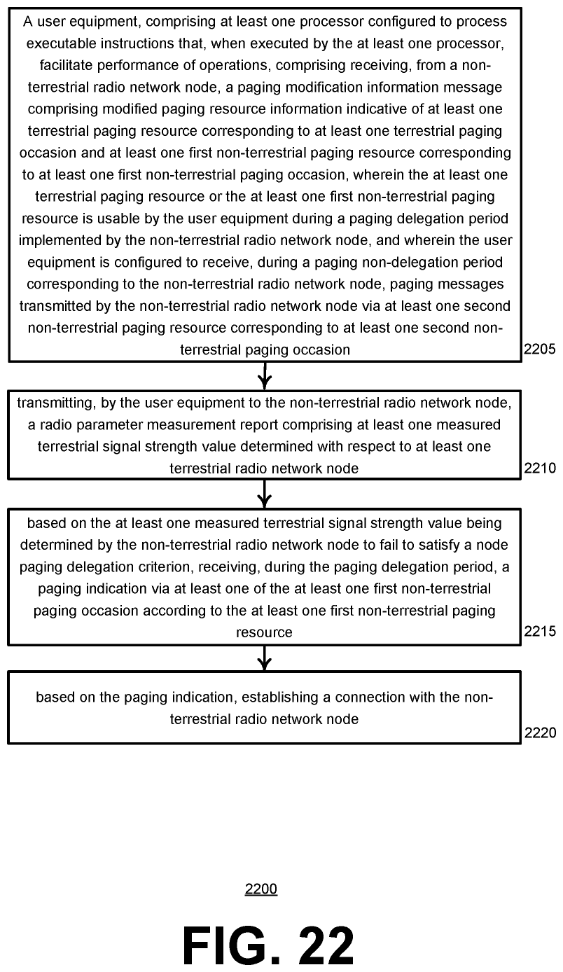

Turning now to FIG. 22, the figure illustrates an example user equipment 2200, comprising at block 2205 at least one processor configured to process executable instructions that, when executed by the at least one processor, facilitate performance of operations, comprising receiving, from a non-terrestrial radio network node, a paging modification information message comprising modified paging resource information indicative of at least one terrestrial paging resource corresponding to at least one terrestrial paging occasion and at least one first non-terrestrial paging resource corresponding to at least one first non-terrestrial paging occasion, wherein the at least one terrestrial paging resource or the at least one first non-terrestrial paging resource is usable by the user equipment during a paging delegation period implemented by the non-terrestrial radio network node, and wherein the user equipment is configured to receive, during a paging non-delegation period corresponding to the non-terrestrial radio network node, paging messages transmitted by the non-terrestrial radio network node via at least one second non-terrestrial paging resource corresponding to at least one second non-terrestrial paging occasion; at block 2210 transmitting, by the user equipment to the non-terrestrial radio network node, a radio parameter measurement report comprising at least one measured terrestrial signal strength value determined with respect to at least one terrestrial radio network node; at block 2215 based on the at least one measured terrestrial signal strength value being determined by the non-terrestrial radio network node to fail to satisfy a node paging delegation criterion, receiving, during the paging delegation period, a paging indication via at least one of the at least one first non-terrestrial paging occasion according to the at least one first non-terrestrial paging resource; and at block 2220 based on the paging indication, establishing a connection with the non-terrestrial radio network node.

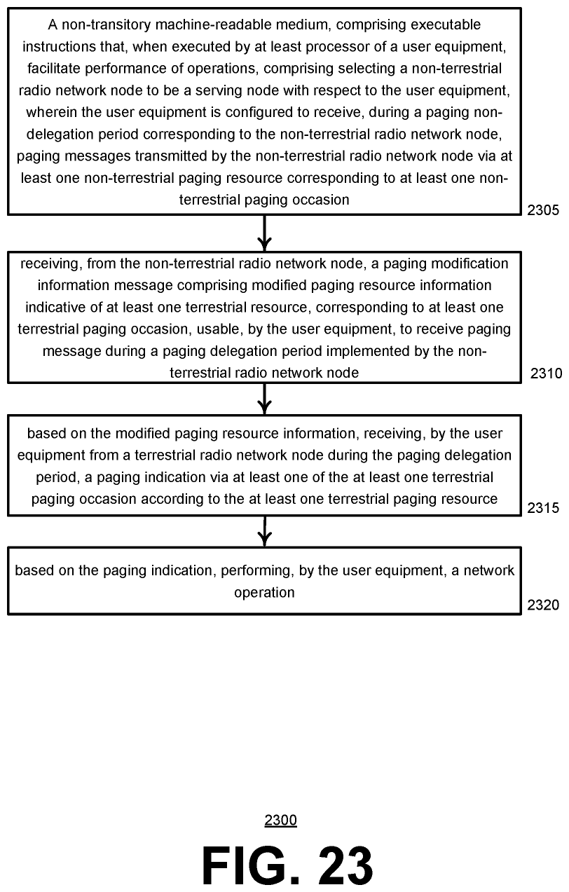

Turning now to FIG. 23, the figure illustrates a non-transitory machine-readable medium 2300 comprising at block 2305 executable instructions that, when executed by at least one processor of a user equipment, facilitate performance of operations, comprising selecting a non-terrestrial radio network node to be a serving node with respect to the user equipment, wherein the user equipment is configured to receive, during a paging non-delegation period corresponding to the non-terrestrial radio network node, paging messages transmitted by the non-terrestrial radio network node via at least one non-terrestrial paging resource corresponding to at least one non-terrestrial paging occasion; at block 2310 receiving, from the non-terrestrial radio network node, a paging modification information message comprising modified paging resource information indicative of at least one terrestrial resource, corresponding to at least one terrestrial paging occasion, usable, by the user equipment, to receive paging message during a paging delegation period implemented by the non-terrestrial radio network node; at block 2315 based on the modified paging resource information, receiving, by the user equipment from a terrestrial radio network node during the paging delegation period, a paging indication via at least one of the at least one terrestrial paging occasion according to the at least one terrestrial paging resource; and at block 2320 based on the paging indication, performing, by the user equipment, a network operation.

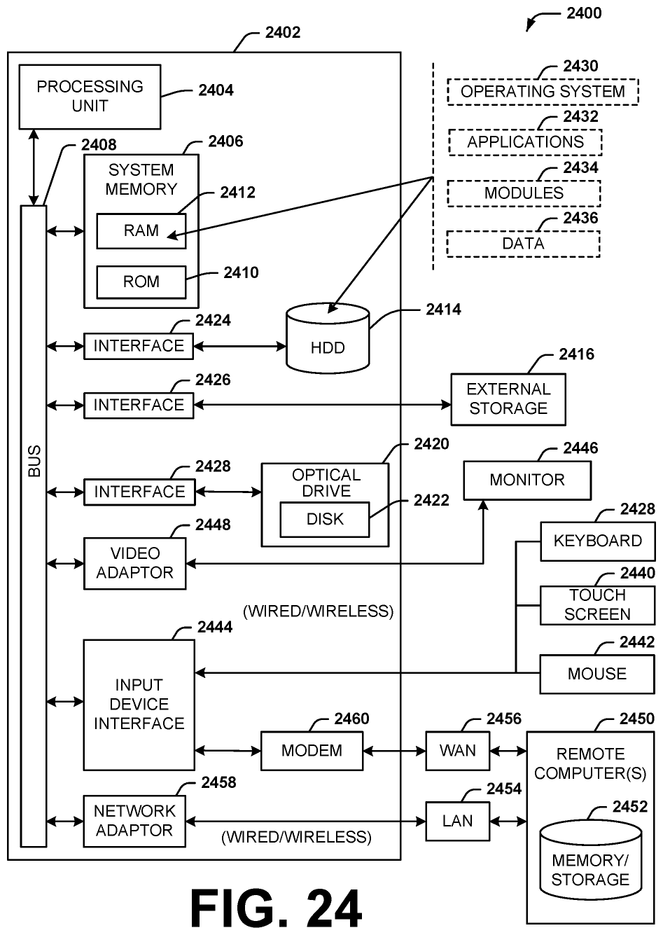

In order to provide additional context for various embodiments described herein, FIG. 24 and the following discussion are intended to provide a brief, general description of a suitable computing environment 2400 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors and may include a cache memory. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data.

Computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and an optical disk drive 2420 (e.g., which can read or write from a CD-ROM disc, a DVD, a BD, etc.). While the internal HDD 2414 is illustrated as located within the computer 2402, the internal HDD 2414 can also be configured for external use in a suitable chassis (not shown). Additionally, while not shown in environment 2400, a solid-state drive (SSD) could be used in addition to, or in place of, an HDD 2414. The HDD 2414, external storage device(s) 2416 and optical disk drive 2420 can be connected to the system bus 2408 by an HDD interface 2424, an external storage interface 2426 and an optical drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, and/or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can comprise a security module, such as a trusted processing module (TPM). For instance, with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired and/or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 and/or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the internet.

When used in a LAN networking environment, the computer 2402 can be connected to the local network 2454 through a wired and/or wireless communication network interface or adapter 2458. The adapter 2458 can facilitate wired or wireless communication to the LAN 2454, which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 and/or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning to FIG. 25, the figure illustrates a block diagram of an example UE 2560. UE 2560 may comprise a smart phone, a wireless tablet, a laptop computer with wireless capability, a wearable device, a machine device that may facilitate vehicle telematics, a tracking device, remote sensing devices, and the like. UE 2560 comprises a first processor 2530, a second processor 2532, and a shared memory 2534. UE 2560 includes radio front end circuitry 2562, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 2562 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 25, UE 2560 may also include a SIM 2564, or a SIM profile, which may comprise information stored in a memory (memory 2534 or a separate memory portion), for facilitating wireless communication with RAN 105 or core network 130 shown in FIG. 1. FIG. 25 shows SIM 2564 as a single component in the shape of a conventional SIM card, but it will be appreciated that SIM 2564 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2564 and another device, which may be a component of RAN 105 or core network 130 shown in FIG. 1). A SIM profile 2564 may also comprise identifying information that is unique to the SIM, or SIM profile, such as, for example, an International Mobile Subscriber Identity (“IMSI”) or information that may make up an IMSI.

SIM 2564 is shown coupled to both the first processor portion 2530 and the second processor portion 2532. Such an implementation may provide an advantage that first processor portion 2530 may not need to request or receive information or data from SIM 2564 that second processor 2532 may request, thus eliminating the use of the first processor acting as a ‘go-between’ when the second processor uses information from the SIM in performing its functions and in executing applications. First processor 2530, which may be a modem processor or a baseband processor, is shown smaller than processor 2532, which may be a more sophisticated application processor, to visually indicate the relative levels of sophistication (i.e., processing capability and performance) and corresponding relative levels of operating power consumption levels between the two processor portions. Keeping the second processor portion 2532 asleep/inactive/in a low power state when UE 2560 does not need it for executing applications and processing data related to an application provides an advantage of reducing power consumption when the UE only needs to use the first processor portion 2530 while in listening mode for monitoring routine configured bearer management and mobility management/maintenance procedures, or for monitoring search spaces that the UE has been configured to monitor while the second processor portion remains inactive/asleep.

UE 2560 may also include sensors 2566, such as, for example, temperature sensors, accelerometers, gyroscopes, barometers, moisture sensors, and the like that may provide signals to the first processor 2530 or second processor 2532. Output devices 2568 may comprise, for example, one or more visual displays (e.g., computer monitors, VR appliances, and the like), acoustic transducers, such as speakers or microphones, vibration components, and the like. Output devices 2568 may comprise software that interfaces with output devices, for example, visual displays, speakers, microphones, touch sensation devices, smell or taste devices, and the like, that are external to UE 2560.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QoS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission or discontinuous transmit |
| DRX | Discontinuous reception or discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a user equipment comprising at least one processor from a non-terrestrial radio network node, a paging modification information message comprising modified paging resource information indicative of at least one first paging resource, corresponding to at least one first paging occasion, usable by the user equipment during a paging delegation period implemented by the non-terrestrial radio network node, wherein the user equipment is configured to receive, during a paging non-delegation period corresponding to the non-terrestrial radio network node, paging messages transmitted by the non-terrestrial radio network node via at least one second paging resource corresponding to at least one second paging occasion;
based on the modified paging resource information, receiving, by the user equipment during the paging delegation period, a paging indication via at least one of the at least one first paging occasion according to the at least one first paging resource; and
based on the paging indication, performing, by the user equipment, a network operation.

2. The method of claim 1, further comprising:
determining, by the user equipment, that the paging indication is directed to the user equipment to result in a determined paging indication,
wherein, responsive to the determined paging indication being determined to be directed to the user equipment, the performing of the network operation comprises transitioning to an active mode.

3. The method of claim 1, wherein the at least one first paging resource is a terrestrial paging resource corresponding to a terrestrial radio network node, and wherein the performing of the network operation comprises establishing a connection with the terrestrial radio network node.

4. The method of claim 1, further comprising:
transmitting, by the user equipment to the non-terrestrial radio network node, a radio parameter measurement report comprising at least one measured terrestrial signal strength value determined with respect to at least the terrestrial radio network node,
wherein, based on at least one of the at least one measured terrestrial signal strength value being determined by the non-terrestrial radio network node to fail to satisfy a node paging delegation criterion, the at least one first paging resource comprises a non-terrestrial paging resource corresponding to the non-terrestrial radio network node.

5. The method of claim 4, wherein the performing of the network operation comprises establishing a connection with the non-terrestrial radio network node.

6. The method of claim 1, wherein the user equipment is a non-terrestrial-network user equipment that is associated with the non-terrestrial radio network node, and wherein the at least one first paging resource comprises at least one shared paging occasion resource usable by at least one terrestrial user equipment associated with a terrestrial radio network node and usable by the non-terrestrial-network user equipment to receive, during the paging delegation period, at least one paging message transmitted by the terrestrial radio network node.

7. The method of claim 6, wherein the at least one first paging resource further comprises at least one paging occasion type occasion resource usable, by the non-terrestrial-network user equipment or the at least one terrestrial user equipment, to receive a paging occasion type indication indicative of at least one shared paging occasion comprising at least one paging message directed to at least one of the at least one terrestrial user equipment or a group of non-terrestrial-network user equipment comprising the non-terrestrial-network user equipment.

8. The method of claim 7, further comprising:
receiving, by the non-terrestrial-network user equipment via the at least one paging occasion type occasion resource, a paging occasion type indication indicative that the at least one shared paging occasion comprises a paging message directed to the non-terrestrial-network user equipment; and
receiving, by the non-terrestrial-network user equipment via the at least one shared paging occasion resource, the paging message.

9. The method of claim 8, wherein the network operation further comprises, responsive to the paging message, establishing a connection with the non-terrestrial radio network node.

10. The method of claim 7, further comprising:
receiving, by the non-terrestrial-network user equipment via the at least one paging occasion type occasion resource, a paging occasion type indication indicative that the at least one shared paging occasion excludes a paging message directed to the non-terrestrial-network user equipment,
wherein the network operation further comprises avoiding transitioning from an idle state to a connected state.

11. The method of claim 1, wherein the modified paging resource information comprises at least one paging delegation time indication indicative of the paging delegation period.

12. A user equipment, comprising:
at least one processor configured to process executable instructions that, when executed by the at least one processor, facilitate performance of operations, comprising:
receiving, from a non-terrestrial radio network node, a paging modification information message comprising modified paging resource information indicative of at least one terrestrial paging resource corresponding to at least one terrestrial paging occasion and at least one first non-terrestrial paging resource corresponding to at least one first non-terrestrial paging occasion, wherein the at least one terrestrial paging resource or the at least one first non-terrestrial paging resource is usable by the user equipment during a paging delegation period implemented by the non-terrestrial radio network node, and wherein the user equipment is configured to receive, during a paging non-delegation period corresponding to the non-terrestrial radio network node, paging messages transmitted by the non-terrestrial radio network node via at least one second non-terrestrial paging resource corresponding to at least one second non-terrestrial paging occasion;
transmitting, by the user equipment to the non-terrestrial radio network node, a radio parameter measurement report comprising at least one measured terrestrial signal strength value determined with respect to at least one terrestrial radio network node;
based on the at least one measured terrestrial signal strength value being determined by the non-terrestrial radio network node to fail to satisfy a node paging delegation criterion, receiving, during the paging delegation period, a paging indication via at least one of the at least one first non-terrestrial paging occasion according to the at least one first non-terrestrial paging resource; and
based on the paging indication, establishing a connection with the non-terrestrial radio network node.

13. The user equipment of claim 12, wherein the at least one terrestrial paging occasion or the at least one first non-terrestrial paging occasion is respectively associated in the paging modification information message with the at least one second non-terrestrial paging occasion.

14. A non-transitory machine-readable medium, comprising executable instructions that, when executed by at least processor of a user equipment, facilitate performance of operations, comprising:
selecting a non-terrestrial radio network node to be a serving node with respect to the user equipment, wherein the user equipment is configured to receive, during a paging non-delegation period corresponding to the non-terrestrial radio network node, paging messages transmitted by the non-terrestrial radio network node via at least one non-terrestrial paging resource corresponding to at least one non-terrestrial paging occasion;
receiving, from the non-terrestrial radio network node, a paging modification information message comprising modified paging resource information indicative of at least one terrestrial resource, corresponding to at least one terrestrial paging occasion, usable, by the user equipment, to receive paging message during a paging delegation period implemented by the non-terrestrial radio network node;
based on the modified paging resource information, receiving, by the user equipment from a terrestrial radio network node during the paging delegation period, a paging indication via at least one of the at least one terrestrial paging occasion according to the at least one terrestrial paging resource; and
based on the paging indication, performing, by the user equipment, a network operation.

15. The non-transitory machine-readable medium claim 14, wherein the user equipment is a non-terrestrial-network user equipment based on selecting of the non-terrestrial radio network node, and wherein the at least one terrestrial paging resource comprises at least one shared paging occasion resource usable by at least one terrestrial user equipment that has selected the terrestrial radio network node to be a serving node with respect to the at least one terrestrial user equipment and usable by the at least one non-terrestrial-network user equipment to receive, during the paging delegation period, at least one paging message transmitted by the terrestrial radio network node.

16. The non-transitory machine-readable medium claim 15, wherein the at least one terrestrial paging resource further comprises at least one paging occasion type occasion resource usable, by the non-terrestrial-network user equipment or the at least one terrestrial user equipment, to receive a paging occasion type indication indicative of at least one shared paging occasion comprising at least one paging message directed to at least one of the at least one terrestrial user equipment or a group of non-terrestrial user equipment comprising the non-terrestrial-network user equipment.

17. The non-transitory machine-readable medium of claim 16, wherein the operations further comprise:
receiving, via the at least one paging occasion type occasion resource, a paging occasion type indication indicative that the at least one shared paging occasion comprises a paging message directed to the non-terrestrial-network user equipment; and
receiving, via the at least one shared paging occasion resource, the paging message.

18. The non-transitory machine-readable medium of claim 17, wherein the network operation further comprises, responsive to the paging message, establishing a connection with the non-terrestrial radio network node.

19. The non-transitory machine-readable medium of claim 18, wherein the operations further comprise:
receiving, by the non-terrestrial-network user equipment via the at least one paging occasion type occasion resource, a paging occasion type indication indicative that the at least one shared paging occasion excludes a paging message directed to the non-terrestrial-network user equipment,
wherein the network operation further comprises avoiding transitioning from an idle state to a connected state.

20. The non-transitory machine-readable medium of claim 16, wherein the at least one paging occasion type occasion resource is smaller than the at least one shared paging occasion resource.
